(19) United States
(12) Patent Application Publication
(10) Pub. No.: US 2026/0174096 A1
(43) Pub. Date: Jun. 25, 2026

(54) Micro Puree Machine for Extrudable Processed Ingredients

(71) Applicant: SharkNinja Operating LLC, Needham, MA (US)

(72) Inventors: Craig White, Newton, NH (US); Caroline Schliep, Johnston, RI (US); Olivia Kivel, Somerville, MA (US); Sarah Hodge, Wayland, MA (US)

(21) Appl. No.: 18/987,922

(22) Filed: Dec. 19, 2024

(51) Int. Cl. A23G 9/22; A23G 9/12; A23G 9/28

(52) U.S. Cl. CPC A23G 9/228; A23G 9/12; A23G 9/224; A23G 9/28

(57) ABSTRACT

A micro-puree machine, including a blending assembly configured to process frozen ingredients; a user interface comprising at least two operation mode input components and at least one program input component, wherein at least one of the at least two operation mode input components is associated with an operation mode suitable for extrudable processed ingredients; and a controller configured to: receive a first selection associated with an operation mode based on an activated operation mode input component; receive a second selection associated with a program based on an activated program input component; determine a set of operation parameters for controlling the blending assembly based on the first selection and the second selection, wherein the set of operation parameters varies based on the activated operation mode input component of the at least two operation mode input components; and control the blending assembly based on the set of operation parameters.

### BACKGROUND

### 1. Technical Field

This disclosure relates generally to micro-puree machines and, in non-limiting embodiments or aspects, to user interfaces for micro-puree machines and methods of controlling micro-puree machines using user interfaces.

### 2. Technical Considerations

Domestic kitchen appliances for making ice creams, gelatos, frozen yogurts, sorbets, and the like, may begin with a series of non-frozen ingredients in a mixing bowl. The non-frozen ingredients may then be churned by one or more stirring apparatus while a refrigeration mechanism simultaneously freezes the ingredients. These devices have a number of shortcomings including, but not limited to, high time and procedural effort required to complete the frozen food-making process. Machines of this nature are also often impractical for preparing non-dessert (e.g., lower sugar content) food products. Furthermore, machines of this nature often have fixed, preset function inputs and limited user feedback, which greatly limits the utility of the machine.

There is a need in the art for a machine to prepare a frozen food product from a pre-frozen ingredient or combination of ingredients. There is a further need in the art for such a machine to be dynamically adaptable to user preferences and input settings.

### SUMMARY

In accordance with one aspect, the present disclosure is directed to a micro-puree machine comprising: a blending assembly configured to process frozen ingredients in a bowl that is removably attachable to the micro-puree machine; a user interface comprising at least two operation mode input components and at least one program input component, wherein at least one of the at least two operation mode input components is associated with an operation mode suitable for extrudable processed ingredients; and a controller, wherein the controller is configured to: receive, via the user interface, a first selection associated with an operation mode based on an activated operation mode input component of the at least two operation mode input components; receive, via the user interface, a second selection associated with a program based on an activated program input component of the at least one program input component; determine a set of operation parameters for controlling the blending assembly based on the first selection and the second selection, wherein the set of operation parameters varies based on the activated operation mode input component of the at least two operation mode input components; and control the blending assembly based on the set of operation parameters.

In some non-limiting embodiments or aspects, the set of operation parameters may include a descent blade speed for the blending assembly.

In some non-limiting embodiments or aspects, the descent blade speed may be between 1200 RPM and 2000 RPM.

In some non-limiting embodiments or aspects, the set of operation parameters may include a descent time for the blending assembly.

In some non-limiting embodiments or aspects, the descent time may be between 60 seconds and 240 seconds.

In some non-limiting embodiments or aspects, the set of operation parameters may include a hold at bottom blade speed for the blending assembly.

In some non-limiting embodiments or aspects, the hold at bottom blade speed may be between 500 RPM and 2000 RPM.

In some non-limiting embodiments or aspects, the set of operation parameters may include a retraction blade speed for the blending assembly.

In some non-limiting embodiments or aspects, the retraction blade speed may be between 500 RPM and 2000 RPM.

In some non-limiting embodiments or aspects, the set of operation parameters may include a retraction time for the blending assembly.

In some non-limiting embodiments or aspects, the retraction time may be between 30 seconds and 180 seconds.

In some non-limiting embodiments or aspects, the set of operation parameters may include a hold at top blade speed for the blending assembly.

In some non-limiting embodiments or aspects, the hold at top blade speed may be between 500 RPM and 2000 RPM.

In some non-limiting embodiments or aspects, the micro-puree machine may further comprise an extruding assembly configured to extrude processed ingredients from the bowl.

In some non-limiting embodiments or aspects, the program may be associated with a first set of predetermined operating parameters for controlling the blending assembly for a first operation mode, and a second set of predetermined operating parameters for controlling the blending assembly for a second operation mode, wherein the first set of predetermined operating parameters may be different than the second set of predetermined operating parameters.

In some non-limiting embodiments or aspects, the first selection may be associated with the operation mode suitable for extrudable processed ingredients.

According to non-limiting embodiments or aspects, a method of controlling a micro-puree machine is provided, the micro puree machine comprising a blending assembly configured to process frozen ingredients in a bowl that is removably attachable to the micro-puree machine, a user interface comprising at least two operation mode input components and at least one program input component, wherein at least one of the at least two operation mode input components is associated with an operation mode suitable for extrudable processed ingredients, and a controller, the method comprising: receiving, with the controller via the user interface, a first selection associated with an operation mode based on an activated operation mode input component of the at least two operation mode input components; receiving, with the controller via the user interface, a second selection associated with a program based on an activated program input component of the at least one program input component; determining, with the controller, a set of operation parameters for controlling the blending assembly based on the first selection and the second selection, wherein the set of operation parameters determined based on the first selection and the second selection varies based on the activated operation mode input component of the at least two operation mode input components; and controlling, with the controller, the blending assembly based on the set of operation parameters.

In some non-limiting embodiments or aspects, the at least one program input component may comprise a plurality of program input components, and the set of operation parameters determined based on the first selection and the second selection may vary based on the activated program input component of the plurality of program input components.

In some non-limiting embodiments or aspects, the program may be associated with a first set of predetermined operating parameters for controlling the blending assembly for a first operation mode, and a second set of predetermined operating parameters for controlling the blending assembly for a second operation mode, and the first set of predetermined operating parameters may be different than the second set of predetermined operating parameters.

In some non-limiting embodiments or aspects, the first selection may be associated with the operation mode suitable for extrudable processed ingredients.

Further examples of the present disclosure will now be described in the following numbered clauses.

Clause 1: A micro-puree machine comprising: a blending assembly configured to process frozen ingredients in a bowl that is removably attachable to the micro-puree machine; a user interface comprising at least two operation mode input components and at least one program input component, wherein at least one of the at least two operation mode input components is associated with an operation mode suitable for extrudable processed ingredients; and a controller, wherein the controller is configured to: receive, via the user interface, a first selection associated with an operation mode based on an activated operation mode input component of the at least two operation mode input components; receive, via the user interface, a second selection associated with a program based on an activated program input component of the at least one program input component; determine a set of operation parameters for controlling the blending assembly based on the first selection and the second selection, wherein the set of operation parameters varies based on the activated operation mode input component of the at least two operation mode input components; and control the blending assembly based on the set of operation parameters.

Clause 2: The micro-puree machine of clause 1, wherein the set of operation parameters includes a descent blade speed for the blending assembly.

Clause 3: The micro-puree machine of clause 2, wherein the descent blade speed is between 1200 RPM and 2000 RPM.

Clause 4: The micro-puree machine of any of clauses 1-3, wherein the set of operation parameters includes a descent time for the blending assembly.

Clause 5: The micro-puree machine of clause 4, wherein the descent time is between 60 seconds and 240 seconds.

Clause 6: The micro-puree machine of any of clauses 1-5, wherein the set of operation parameters includes a hold at bottom blade speed for the blending assembly.

Clause 7: The micro-puree machine of clause 6, wherein the hold at bottom blade speed is between 500 RPM and 2000 RPM.

Clause 8: The micro-puree machine of any of clauses 1-7, wherein the set of operation parameters includes a retraction blade speed for the blending assembly.

Clause 9: The micro-puree machine of clause 8, wherein the retraction blade speed is between 500 RPM and 2000 RPM.

Clause 10: The micro-puree machine of any of clauses 1-9, wherein the set of operation parameters includes a retraction time for the blending assembly.

Clause 11: The micro-puree machine of clause 10, wherein the retraction time is between 30 seconds and 180 seconds.

Clause 12: The micro-puree machine of any of clauses 1-11, wherein the set of operation parameters includes a hold at top blade speed for the blending assembly.

Clause 13: The micro-puree machine of clause 12, wherein the hold at top blade speed is between 500 RPM and 2000 RPM.

Clause 14: The micro-puree machine of any of clauses 1-13, further comprising an extruding assembly configured to extrude processed ingredients from the bowl.

Clause 15: The micro-puree machine of any of clauses 1-14, wherein the program is associated with a first set of predetermined operating parameters for controlling the blending assembly for a first operation mode, and a second set of predetermined operating parameters for controlling the blending assembly for a second operation mode, wherein the first set of predetermined operating parameters is different than the second set of predetermined operating parameters.

Clause 16: The micro-puree machine of any of clauses 1-15, wherein the first selection is associated with the operation mode suitable for extrudable processed ingredients.

Clause 17: A method of controlling a micro-puree machine comprising a blending assembly configured to process frozen ingredients in a bowl that is removably attachable to the micro-puree machine, a user interface comprising at least two operation mode input components and at least one program input component, wherein at least one of the at least two operation mode input components is associated with an operation mode suitable for extrudable processed ingredients, and a controller, the method comprising: receiving, with the controller via the user interface, a first selection associated with an operation mode based on an activated operation mode input component of the at least two operation mode input components; receiving, with the controller via the user interface, a second selection associated with a program based on an activated program input component of the at least one program input component; determining, with the controller, a set of operation parameters for controlling the blending assembly based on the first selection and the second selection, wherein the set of operation parameters determined based on the first selection and the second selection varies based on the activated operation mode input component of the at least two operation mode input components; and controlling, with the controller, the blending assembly based on the set of operation parameters.

Clause 18: The method of clause 17, wherein the at least one program input component comprises a plurality of program input components, and wherein the set of operation parameters determined based on the first selection and the second selection varies based on the activated program input component of the plurality of program input components.

Clause 19: The method of clause 17 or clause 18, wherein the program is associated with a first set of predetermined operating parameters for controlling the blending assembly for a first operation mode, and a second set of predetermined operating parameters for controlling the blending assembly for a second operation mode, wherein the first set of predetermined operating parameters is different than the second set of predetermined operating parameters.

Clause 20: The method of any of clauses 17-19, wherein the first selection is associated with the operation mode suitable for extrudable processed ingredients.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures in which:

FIG. 1A shows an isometric view of a micro-puree machine, according to some non-limiting embodiments or aspects;

FIG. 1B shows the micro-puree machine of FIG. 1A with the bowl assembly disassembled from the housing, according to some non-limiting embodiments or aspects;

FIGS. 1C-1G illustrate embodiments of extrusion assemblies, bowl assemblies, and/or nozzle assemblies of the micro-puree machine of FIG. 1A, according to some non-limiting embodiments or aspects;

FIG. 2A illustrates a portion of another micro-puree machine, according to some non-limiting embodiments or aspects;

FIG. 2B illustrates a reversible bowl assembly that may be coupled to the micro-puree machine of FIG. 2A, according to some embodiments of the disclosure;

FIG. 3A shows another reversible bowl assembly, according to some non-limiting embodiments or aspects;

FIG. 3B shows a blade of the reversible bowl assembly of FIG. 3A, according to some non-limiting embodiments or aspects;

FIG. 3C is a cut-away view of the reversible bowl assembly and first lid of FIGS. 3A and 3B, according to some non-limiting embodiments or aspects;

FIG. 3D shows a detailed view of an embodiment of a plunger coupled to the underside of second lid, according to some non-limiting embodiments or aspects;

FIGS. 4A and 4B illustrate the use of the reversible bowl assembly of FIGS. 3A-3D, according to some non-limiting embodiments or aspects;

FIGS. 5A-5F illustrate another micro-puree machine, according to some non-limiting embodiments or aspects;

FIG. 6A illustrates a nozzle control assembly of a micro-puree machine, according to some non-limiting embodiments or aspects;

FIGS. 6B-6I illustrate the use of the nozzle control assembly of FIG. 6A, according to some non-limiting embodiments or aspects;

FIGS. 7A-7F illustrate another nozzle control assembly of a micro-puree machine in an open position, according to some non-limiting embodiments or aspects;

FIGS. 7G-7J illustrate the nozzle control assembly of FIGS. 7A-7F in a closed position, according to some non-limiting embodiments or aspects;

FIG. 8 shows a user interface for a micro-puree machine, according to some non-limiting embodiments or aspects;

FIG. 9A shows a sequence of output displayed in a user interface of a micro-puree machine, according to some non-limiting embodiments or aspects;

FIG. 9B shows a sequence of output displayed in a user interface of a micro-puree machine, according to some non-limiting embodiments or aspects;

FIG. 10A shows exemplary displayed output in a user interface of a micro-puree machine, according to some non-limiting embodiments or aspects;

FIG. 10B shows exemplary displayed output in a user interface of a micro-puree machine, according to some non-limiting embodiments or aspects;

FIG. 11 shows a sequence of output displayed in a user interface of a micro-puree machine, according to some non-limiting embodiments or aspects;

FIG. 12 shows a sequence of output displayed in a user interface of a micro-puree machine, according to some non-limiting embodiments or aspects;

FIG. 13 shows a sequence of output displayed in a user interface of a micro-puree machine, according to some non-limiting embodiments or aspects;

FIG. 14 is a schematic diagram of a micro-puree machine, according to some non-limiting embodiments or aspects;

FIG. 15 is a schematic diagram of example components of one or more devices of FIG. 14, according to some non-limiting embodiments or aspects;

FIG. 16 is a flow diagram of a method for controlling a micro-puree machine, according to some non-limiting embodiments or aspects; and

FIG. 17 includes a table of various food processing routines for a micro-puree machine, according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input component, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

Notably, the mechanisms and techniques described herein may be used to configure a machine to process (e.g., micro-puree and perhaps aerate) and extrude ice cream and other frozen ingredients. That is, both the processing and extrusion functions can be performed by a single machine. In such a machine, a same shaft may be used to drive a blade to process the frozen ingredients in a bowl (e.g., a container) and to drive a plunger to extrude the processed ingredients from the bowl. Further, such a machine may include a user interface enabling a user to control the timing of the performance of each function. In some implementations of such a machine, a first shaft may be used to drive processing and a second shaft may be used to drive extrusion, and such implementations may be considered to have a first sub-system or module for processing and a second sub-system or module for extrusion.

In some embodiments, a single lid may be provided (e.g., on an open end of the bowl) that houses (or is coupled to) a blade for processing ingredients, and that also houses (or is coupled to) a plunger for extruding the processed ingredients. In such embodiments, a single shaft driven by one or more motors (e.g., one motor for driving rotation of blade; the other motor for driving linear movement of the driven shaft along its axis) may drive both the processing that uses the blade and the extrusion that uses the plunger, as described in more detail elsewhere herein, and an end of the bowl opposite the lid may include an opening for extrusion of the processed ingredients from the bowl.

In other embodiments, to enable the performance of both functions, the user may flip the processing bowl from a first arrangement, in which the driven shaft engages a blade at a first end of the processing bowl (e.g., the blade housed in or coupled to a first lid at a first open end of the processing bowl), to a second arrangement, in which the driven shaft engages a plunger at a second end of the processing bowl (e.g., the plunger housed in or coupled to a second lid at an open second end of the processing bowl), as described in more detail herein. In such embodiments, the first lid also may include an opening for extruding the ingredients from the bowl during extrusion using the plunger in the second arrangement. Further, in such embodiments, a single shaft driven by one or more motors may drive both the processing by use of the blade and the extrusion by use of the plunger, as described in more detail elsewhere herein.

In other embodiments, to enable the performance of both functions, the user may replace a first lid (e.g., housing or coupled to a blade) for processing from an open end of the processing bowl with a second lid (e.g., housing or coupled to a plunger) for extruding, as described in more detail elsewhere herein. In such embodiments, a single shaft driven by one or more motors may drive both the processing by use of the blade and the extrusion by use of the plunger, or alternatively, a separate shaft may be used for extruding, in which such separate shaft drives the plunger, as described in more detail elsewhere herein.

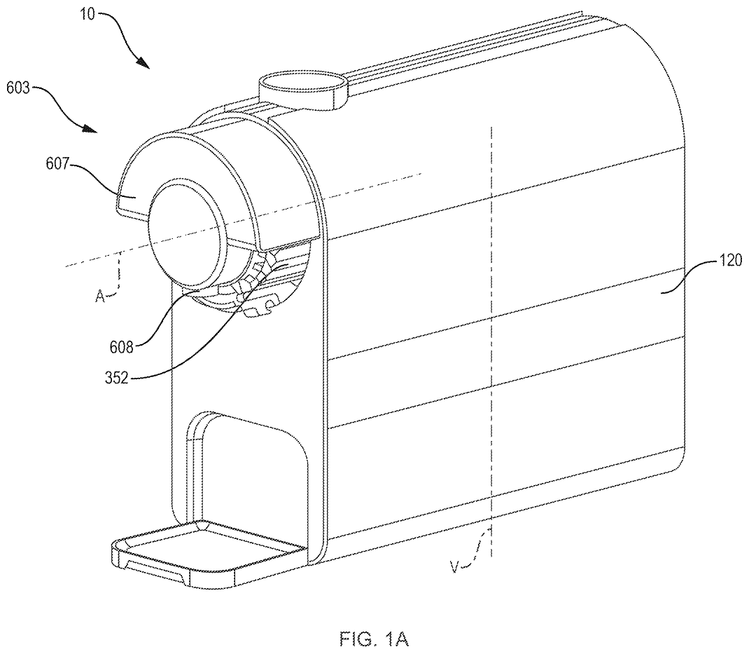

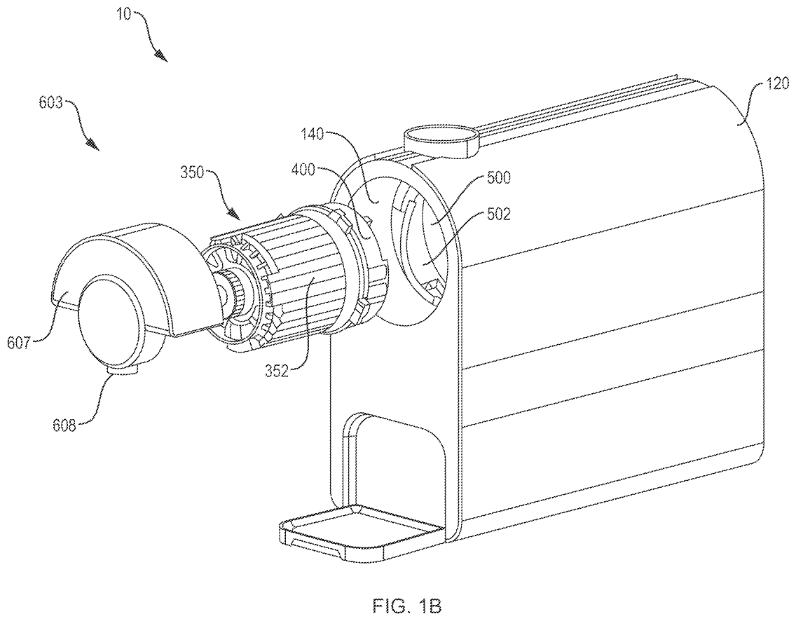

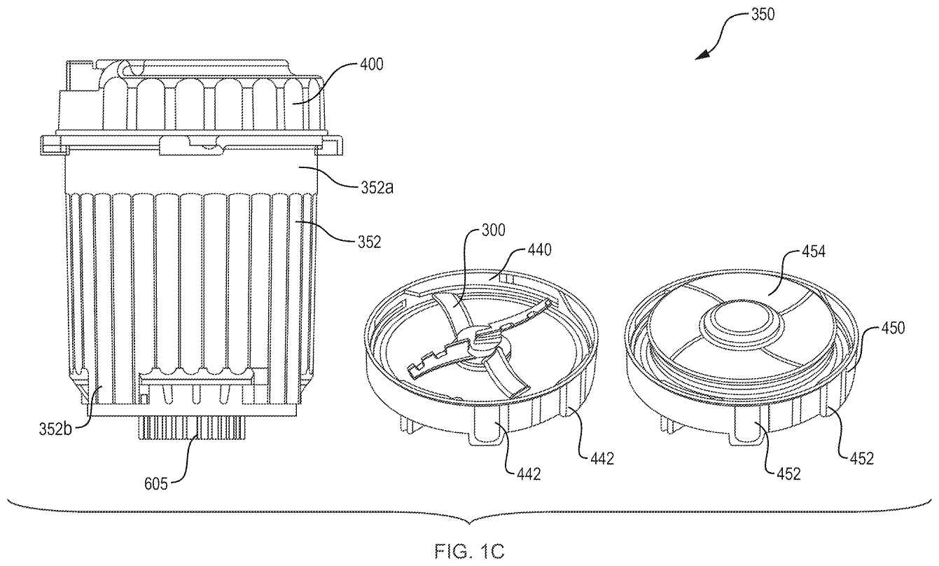

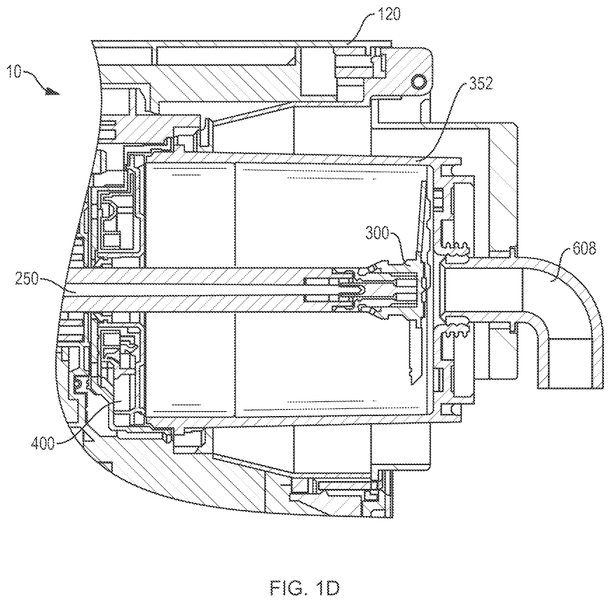

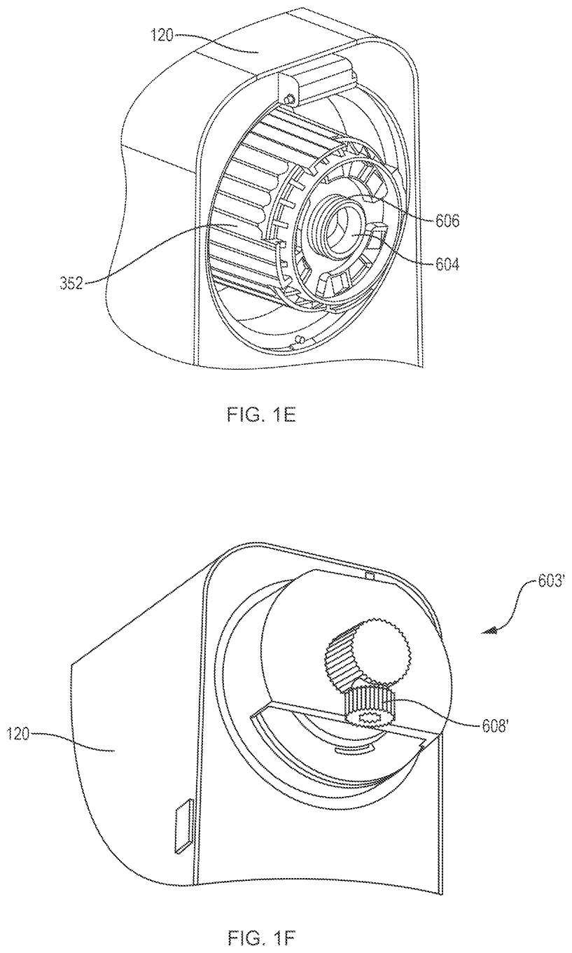

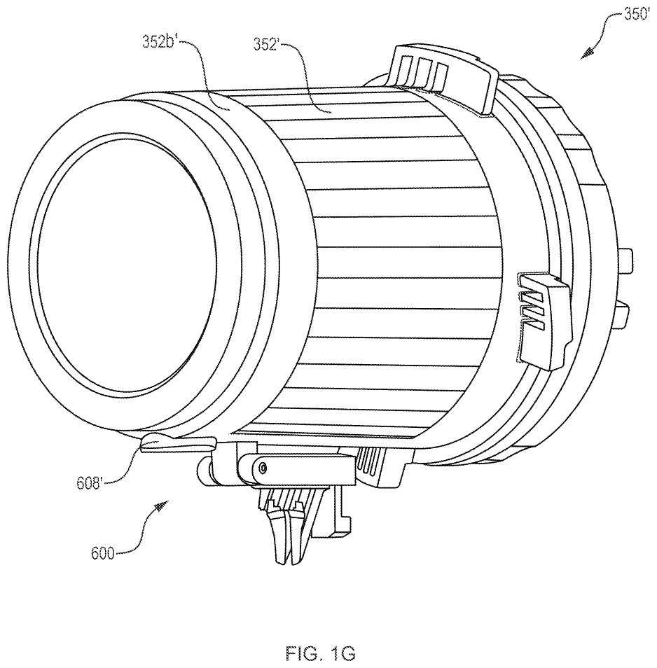

FIG. 1A shows an isometric view of a micro-puree machine 10, according to some embodiments of the present disclosure. FIG. 1B shows the micro-puree machine 10 of FIG. 1A with the bowl assembly 350 disassembled from the housing 120, according to some embodiments of the disclosure. FIGS. 1C-1G illustrate embodiments of the extrusion assemblies, bowl assemblies, and/or nozzle assemblies, according to some embodiments of the present disclosure.

The micro-puree machine 10 may include a housing 120, which may include a user interface (not shown) for receiving user inputs to control the micro-puree machine 10 and/or display information. The micro-puree machine 10 also may include a bowl assembly 350 and a nozzle assembly 603. The combination of a bowl assembly 350, which may include a lid 400 configured for extruding, and a nozzle assembly 603 may be referred to herein as an extruding assembly. The nozzle assembly 603 may include a nozzle housing 607 and a nozzle 608.

The bowl assembly 350 may include a bowl 352 configured to contain one or more processed ingredients, ingredients to be processed, or ingredients being processed. A user may couple the bowl assembly 350 to the housing 120 by rotating the bowl assembly 350 relative to the housing 120 (e.g., using screwing threads or a bayonet connection), or by another coupling mechanism and/or technique. The bowl assembly 350 may be assembled to the housing 120 such that a central axis A of the bowl assembly 350 extends perpendicular to a vertical axis V of the housing 120, as shown. However, the disclosure contemplates that the bowl assembly 350 may be assembled to the housing 120 such that the central axis A extends at an angle between 0 and 90° to the vertical axis, for example, as described in U.S. Pat. No. 11,759,057 to SharkNinja Operating LLC, the entire contents of which are hereby incorporated by reference (the '057 patent), or such that the central axis of the bowl assembly 350 extends parallel to the vertical axis V, for example, as described in U.S. Pat. No. 11,871,765 to SharkNinja Operating LLC, the entire contents of which are hereby incorporated by reference (the '756 patent). In some embodiments, the bowl 352 of the bowl assembly 350 can be manufactured from a disposable material to enhance the convenience of using the micro-puree machine 10. Further, the bowl 352 can be sold as a stand-alone item and can also be prefilled with ingredients to be processed during use of the micro-puree machine 10.

As shown in FIG. 1B, the housing 120 may including a coupling 500 disposed within an opening 140 of the housing 120. An inner surface 502 of the coupling 500 may comprise locating and locking elements for positioning and connecting the bowl assembly 350 to the coupling 500 in two different configurations, as described elsewhere herein. The micro-puree machine 10 may further include a nozzle 608 couplable to the bowl assembly 350 for extruding processed ingredients from the bowl assembly 350. The nozzle 608 may be arranged such that the ingredients are extruded in a vertically downward direction such that a user can place an ice cream cone, cup, bowl, or other edible or non-edible receptacle underneath the nozzle 608 to receive extruded ingredients. The disclosure also contemplates that multiple nozzle shapes may be provided to allow for user customizability. For example, multiple nozzles may be included on a rotatable dial that allows the user to select the desired nozzle shape. In further embodiments, the extrude function may be integrated into a program on the user interface with a predetermined translation speed/flow rate.

As shown in FIG. 1C, the first end 352a of the bowl 352 may be configured to couple to both a first lid 440 and the second lid 450. The first lid 440 may include a blade 300 for processing ingredients, for example, a blade as described in the '765 patent. When the first lid 440 is coupled to the bowl 352 (e.g., via reciprocal threading on the bowl and lid), the bowl assembly 350 may be considered to be in a processing configuration and may be coupled to the housing 120 via coupling 500. The first lid 440 may have locating and locking elements 442 on its exterior sidewall configured to couple to the locating and locking elements on the inner surface 502 of the coupling 500. The second lid 450 may include a plunger 454 for extruding ingredients. The plunger 454 may furthermore include a flexible seal around its perimeter to ensure contact (e.g., maximum contact) with the sidewall of the bowl 352 to allow for optimal (e.g., maximum) extrusion yield. When the second lid 450 is coupled to the bowl 352 (e.g., via reciprocal threading on the bowl and lid), the bowl assembly 350 may be considered to be in an extruding configuration and may be coupled to the housing 120 via coupling 500. The second lid 450 may have locating and locking elements 452 on its exterior sidewall configured to couple to the locating and locking elements on the inner surface 502 of the coupling 500.

The second end 352b of the bowl 352 may include a centrally located opening 604, or an opening that is not centrally located, including a coupling collar. The coupling collar may include threading or other types of coupling features, for example, slots or cams, e.g., for bayoneting. The opening 604 may be enclosed by a cap 605, for example, during processing, which cap 605 may be removed during extruding. The cap 605 may include interior threading (not shown) or other coupling features that allow it to couple to the coupling collar. The opening 604 may further be in fluid communication with a nozzle 608. For example, the opening 604 may be in fluid communication with a nozzle 608 through a conduit (e.g., plastic tubing) that extends from the opening 604 to the nozzle 608, e.g., within nozzle assembly 603. In some embodiments, such a conduit may include one or more sections connected by joints (e.g., an elbow joint) to translate the direction (e.g., horizontal) of extrusion from opening 604 to a direction (e.g., vertically downward) of extrusion from the nozzle 608.

As shown in FIG. 1D, the user may attach the first lid 440 to the bowl 352 and couple the bowl assembly 350 to the micro-puree machine 10 using the coupling features described herein. The first lid 440 may be configured (e.g., as described in the '765 patent) such that, when the first lid 440 is coupling to the housing 120, the blade 300 engages a driven shaft 250 and disengages the first lid 440. Through use of a user interface (e.g., as described in the '057 patent), the user may activate a program that controls the blade 300 to rotate and move (e.g., descend or move horizontally or at an angle) into the ingredients in the bowl 352 to process (e.g., micro-puree) them. It should be appreciated that in some embodiments, as shown in FIG. 1D, the nozzle assembly 603 or one or more components thereof (e.g., nozzle 608) may be coupled to the second end 352b of the bowl 352 (and perhaps to the housing) even when extrusion is not being performed, e.g., during processing. In such embodiments, the opening 604 may be closed, for example, using cap 605 or by other means. FIG. 1E is a bottom view of the bowl assembly 350 while coupled to the housing 120, in which the opening 604 is not covered. In actual use, the opening 604 may be closed, e.g., by cap 605, during processing, or open and coupled to the nozzle assembly 603 during extrusion.

After processing the ingredients in the bowl 352, the user then may remove the bowl assembly 350 from the micro-puree machine 10, remove the first lid 440 from first end 352a, replace it with second lid 450 on the first end 352a, couple the nozzle assembly 603 to the second end 352b of the bowl assembly 350 if not already attached, couple the bowl assembly 350 to the housing 120, and initiate extrusion via the user interface. During extrusion, the driven shaft 250 drives the plunger 454 from the first end 352a of the bowl 352 to the second end 352b of the bowl 352, forcing the processed ingredients to extrude the processed ingredients through the opening 604 and through the nozzle 608.

FIG. 1F illustrates another embodiment of a nozzle assembly 603′, including nozzle 608′, which may be used to extrude processed ingredients, for example, using mechanisms and techniques described herein.

FIG. 1G illustrates another bowl assembly 350′ including the extruding assembly 600, according to some embodiments of the disclosure. As shown in FIG. 1G, the bowl assembly 350′ may include a nozzle 608′ that is integrated with the bottom edge of the bowl 352′, for example, on the sidewall of the bowl 352′ proximate to a second end 352b′ or extending past the second end 352b′. In some embodiments, the bowl assembly 350′ may be configured to be installed to the coupling 500 such that the nozzle 608′ faces vertically downwards when the bowl 352′ is properly installed. During extrusion, the movement of the plunger (e.g., plunger 454) will force the processed ingredients through the nozzle 608′. The nozzle 608′ may be selectively located on the bowl 352′ to optimize the amount of processed ingredients that can be extruded, thus minimizing the amount of yield loss after extrusion. For example, the nozzle 608′ may be located near the bottom edge of the bowl 352′, as shown in FIG. 1G. However, the disclosure contemplates that the nozzle 608′ may alternatively be located at a different longitudinal and/or radial position on the bowl 352′. Bowl assembly 350′ and/or bowl 352′ may be the same or different than bowl assembly 350 and/or bowl 352, respectively.

Advantageously, the micro-puree machine 10 may include a sensor (not shown) that recognizes which lid is installed into the micro-puree machine 10 to restrict certain programs based on the lid functions, which may prevent user error when operating the micro-puree machine 10. For example, the micro-puree machine 10 may only activate the blade 300 when the sensor detects that the bowl 352 is installed in the first configuration in which first lid 440 is coupled to bowl 350 and may only activate the plunger 454 when the sensor detects that the bowl 352 is installed in the second configuration in which first lid 440 is coupled to bowl 350. For example, each of lid 440 and 450 may include distinctive physical and/or electromagnetic features, e.g., as part of locating and locking elements 442 and 452, respectively, for which coupling 500 or other elements of the micro-puree machine 10 may be configured to detect and distinguish first lid 440 from second lid 450.

The housing 120 may house one or more motors and a transmission system (e.g., including gearing) that drive a driven shaft (e.g., driven shaft 250) for engaging the blade 300 and/or plunger 454 when the bowl assembly 350 (coupled to lid 440 or 450, respectively) is coupled to the housing 120 for processing or extruding, respectively, for example, as described in the '765 patent or U.S. Pat. No. 11,882,965 to SharkNinja Operating LLC (the '965 patent), the entire contents of which are hereby incorporated by reference. For example, the one or more motors may include a first motor for driving rotation of the driven shaft 250 via the transmission, which may be used to drive the rotation of the blade 300 during processing, and, if desired (but not necessary) rotating the plunger 454 during extrusion. A second motor may be configured to move the position of the driven shaft 250, via the transmission, along its axis (e.g., back and forth; or up and down), which may be used to drive the back-and-forth movement of the blade 300 into and out of the bowl 350 during processing, and to move the plunger 454 into and out of the bowl 350 during extrusion. In some embodiments, the micro-puree machine 10 may include gearboxes (e.g., high ratio gearboxes) and reinforced internals (not shown) to allow an extruding assembly, as described herein, to withstand high forces and extrude thick outputs from the nozzle 608.

In some embodiments of the disclosure, a reversible bowl assembly may be used, which does not require that a lid be removed between processing and extruding. For example, the reversible bowl assembly may include: a first lid coupled at one end including a blade for processing and an opening for extruding; and a second lid at the other end including a plunger for extruding. Examples of such embodiments will now be described.

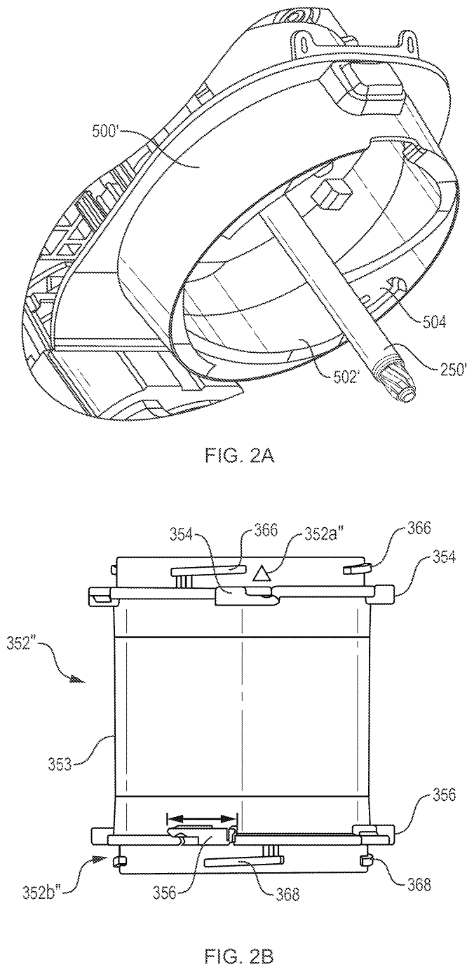

FIG. 2A illustrates an embodiment of a portion of a micro-puree machine including a coupling 500′ for coupling to a bowl assembly, for example, a reversible bowl assembly, in accordance with some embodiments of the disclosure. FIG. 2B illustrates an embodiment of a reversible bowl 352'′ that may be coupled to coupling 500′. The bowl 352″ may include any of a variety of external surfaces. For example, embodiments of the bowl 352″ may have a ribbed or corrugated surface (e.g., like bowl 352 or 352′), or a smooth surface (e.g., bowl 352″). Similarly, bowls 352 and 352″ may have any variety of surfaces, including smooth surfaces.

As shown in FIG. 2A, the driven shaft 250 of the micro-puree machine 10 may extend from the housing 120 into an interior of the coupling 500′ and optionally all the way through the interior of the coupling 500′. The inner surface 502′ of the coupling 500′ may comprise one or more slots 504 sized and shaped to receive at least one projection 354 on an outer surface of a first open end 352a″ of the bowl 352″. In some embodiments, both the first end 352a″ and the second end 352b″ of the bowl 352″ may be open—that is, both the first end 352a″ and the second end 352b″ may not have a top or bottom wall and/or a lid. However, the disclosure is not so limited, and one or both ends 352a″, 352b″ of the bowl 352″ may be closed with a wall or a lid. In some embodiments, the at least one projection 354″ on the bowl 352″ may be four projections 354″ spaced 90 degrees apart about an outer surface of the first end 352a″ of the bowl 352″. However, the disclosure contemplates more or fewer than four projections 354″. In a first configuration of the reversible bowl assembly 350″, the user may rotate the bowl 352″ relative to the coupling 500′ such that the projections 354″ are rotated into the slots 504, coupling (e.g., locking) the bowl 352″ and the coupling 500 together.

The slots 504 also may be sized and shaped to receive at least one projection 354″ on an outer surface of a second open end 352b″ of the bowl 352″. In some embodiments, the at least one projection 354″ may be four projections 354″ spaced 90 degrees apart about an outer surface of the second end 352b″ of the bowl 352″. However, the disclosure contemplates more or fewer than four projections 354″. In a second configuration of the reversible bowl assembly 350″, the user may rotate the bowl 352″ relative to the coupling 500′ such that the projections 354″ are rotated into the slots 504, coupling (e.g., locking) the bowl 352″ and the coupling 500′ together. The first end 352a″ of the bowl 352″ may further comprise threads 366 for coupling to a first lid, while the second end 352b″ of the bowl 352″ may comprise threads 368 for coupling to a second lid, as further described elsewhere herein.

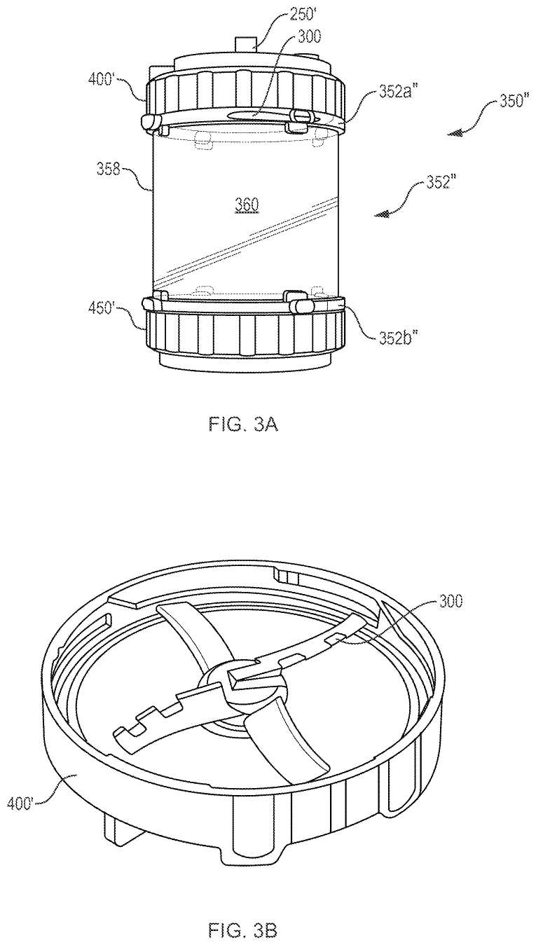

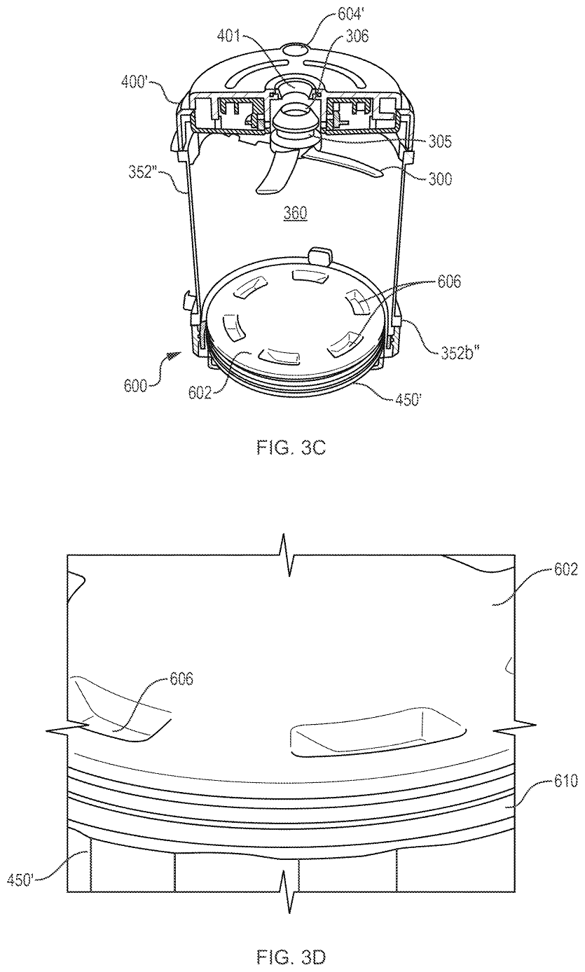

FIG. 3A shows an embodiment of the reversible bowl assembly 350″, assembled according to some embodiments of the disclosure. As shown in FIG. 3A, the bowl 352″ may have an oblong shape and include a cylindrical sidewall 358 defining an interior volume 360 of the bowl 352″. The sidewall 358 may extend between the first open end 352a″ of the bowl 352″ and the second open end 352b″ opposite the first open end 352a″. Embodiments of the sidewall 358 may have various configurations. For example, a cross-section of the sidewall 358 may be circular or polygonal. In addition, a diameter of the sidewall 358 may vary between the first open end 352a″ and the second open end 352b″ (e.g., may be tapered). The first open end 352a″ and the second open end 352b″ may communicate with the interior volume 360 of the bowl 352″. The bowl assembly 350″ may further include a first lid 400′ removably couplable to the first open end 352a″ of the bowl 352″. The first lid 400′ may define an opening 401 (FIG. 3C) configured to couple to a blade 300 for mixing ingredients within the bowl 352″. When the bowl 352″ is installed to the coupling 500′ in the first configuration, the blade 300 may engage with the driven shaft 250′ to rotate and plunge the blade 300 within the ingredients. FIG. 3B shows an embodiment of the blade 300 coupled to the underside of first lid 400′. Some non-limiting examples of the blade 300 are shown in the '765 patent.

FIG. 3C is a cut-away view of the reversible bowl assembly 350″ and the first lid 400′, according to some embodiments of the disclosure, whereas blade 300 and a second lid 450′ are not shown in cut-away form. As shown in FIG. 3C, the blade 300 may include a central support hub 305 including a central opening 306 for engaging the driven shaft 250. In some embodiments, the second lid 450′ may removably couple to the second open end 352b″ of the bowl 352″. The second lid 450′ may include, or be coupled to, a plunger 602 for pushing the ingredients in the bowl 352″ toward an opening 604 in first lid 400′. The plunger 602, alone or in combination with other components (e.g., the second lid 450′, the bowl 352″, or the nozzle 608), may constitute an extruding assembly 600 for extruding processed ingredients from the bowl 352″. The opening 604′ in the first lid 400′ may further be in fluid communication with a nozzle (e.g. nozzle 608). For example, the opening 604′ may be in fluid communication with a nozzle 608 through a conduit (e.g., plastic tubing) that extends from the opening 604′ to the nozzle 608. In some embodiments, such a conduit may include one or more sections connected by joints (e.g., an elbow joint) to translate the direction (e.g., horizontal) of extrusion from opening 604 to a direction (e.g., vertically downward) of extrusion from the nozzle 608.

The plunger 602 may be couplable to the driven shaft 250′ of the micro-puree machine 10 when the bowl assembly 350″ is in the second configuration and the bowl 352″ is installed to the coupling 500′. A surface of the plunger 602 facing the interior volume 360 may include a one or more (e.g., a plurality of) indentations 606. The indentations 606 may prevent frozen ingredients from rotational movement within the bowl 352″ during processing by the blade 300. The plunger 602 may furthermore include a flexible seal 610 around its perimeter to ensure contact (e.g., maximum contact) with the sidewall 358 of the bowl 352″ to allow for optimal (e.g., maximum) extrusion yield.

The micro-puree machine 10 of the embodiments described in relation to FIGS. 2A, 2B, 3A-3D, 4A, and 4B may include one or more motors and a transmission system (e.g., including gearing) that drive a driven shaft (e.g., driven shaft 250′) for engaging the blade 300 and/or plunger 602 when the bowl assembly 350″ (coupled to lid 440′ or 450′, respectively) is coupled to the housing 120 for processing or extruding, for example, as described in the '765 patent or the '965 patent; and may include gearboxes (e.g., high ratio gearboxes) and reinforced internals (not shown) to allow the extruding assembly 600 to withstand high forces and extrude thick outputs from a nozzle 608.

FIG. 3D shows a detailed view of an embodiment of the plunger 602 coupled to the underside of second lid 450′. In some embodiments, the bowl assembly 350″ may be configured such that only the first lid 400′ can couple to the first open end 352a″ of the bowl 352″ and only the second lid 450′ can couple to the second open end 352b″ of the bowl 352″. For example, a configuration of the threads 366 may be different from a configuration of the threads 368 (FIG. 3B) to prevent the user from attaching the wrong lid to the wrong side of the bowl 352″. The bowl 352″ may further include clear indicators (colors, icons, etc.) that would signal to the user which lid goes on which side of the bowl 352″.

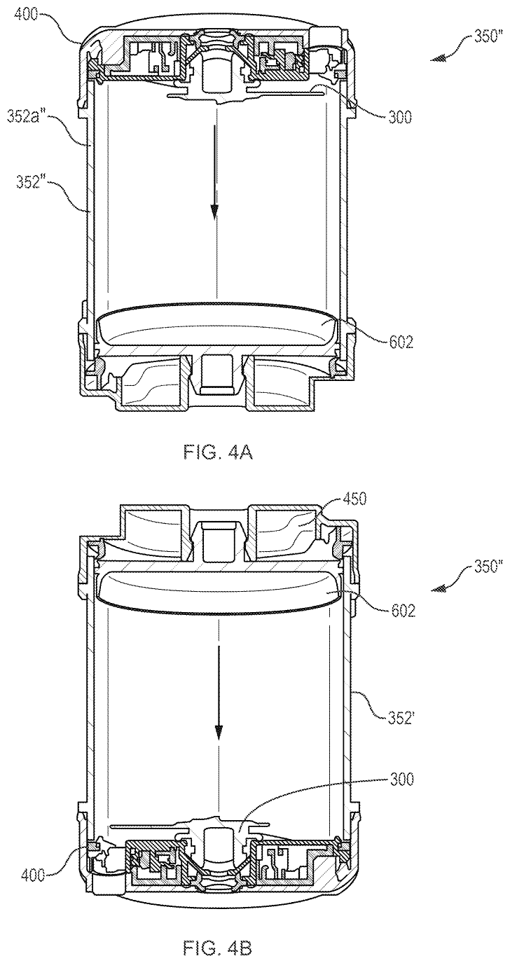

FIGS. 4A and 4B illustrate the use of the reversible bowl assembly 350″, according to some embodiments of the disclosure. As shown in FIG. 4A, a user may first install the bowl assembly 350″ to the micro-puree machine 10 in the first configuration such that the first end 352a″ of the bowl 352″ is secured to the coupling 500′. The user then may select a program at the user interface depending on the desired output (for example, soft serve ice cream, light ice cream, sorbet, gelato, etc.) to spin and plunge the blade 300 into the ingredients in the bowl 352″. For example, the blade 300 may descend into the ingredients and then ascend from the ingredients at one or more predefined rates, while rotating at one or more predefined rates. As shown in FIG. 4B, the user may then remove the bowl assembly 350″ from the coupling 500′, reverse the orientation of the bowl assembly 350″ (e.g.., flip the bowl assembly 350″) and reinstall the second end 352b″ of the bowl 352″ to the coupling 500′ in the second configuration. The user then may select a desired program at the user interface to descend the plunger 602 to extrude the ingredients out through the opening 604′ in the first lid 400′. For example, the plunger 602 may descend into the ingredients to extrude the ingredients out through the opening 604′ and then ascend from the opening 604′ after the extrusion is complete.

While embodiments of the disclosure including performing processing and extrusion using a same driven shaft, in some embodiments, processing and extrusion are performed on different shafts, as will now be described.

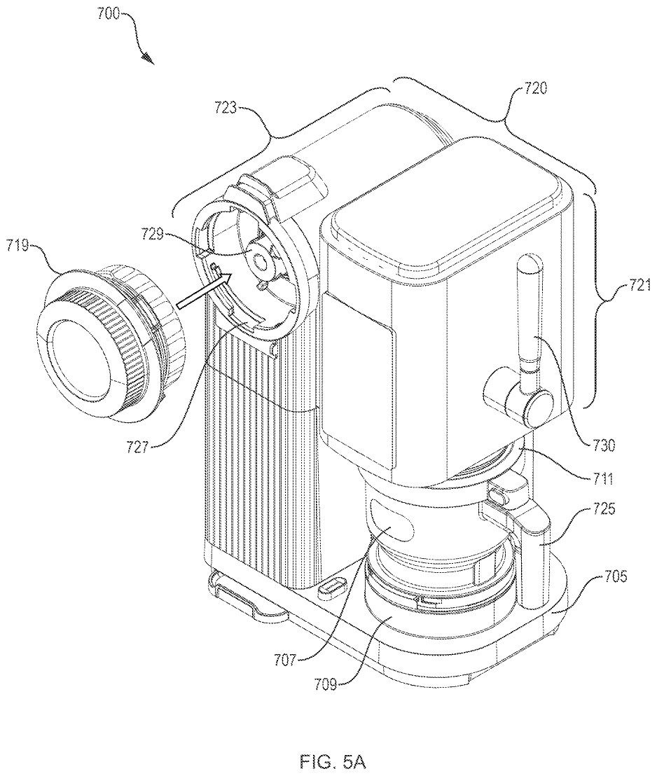

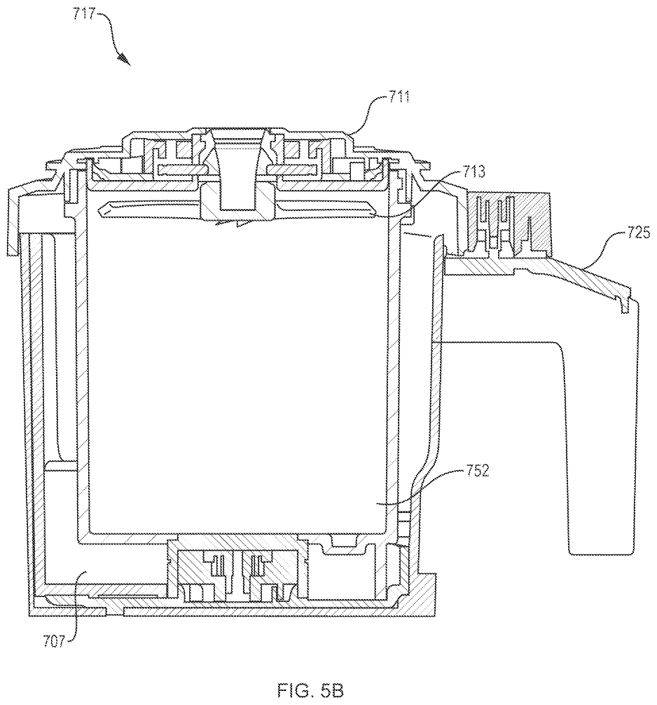

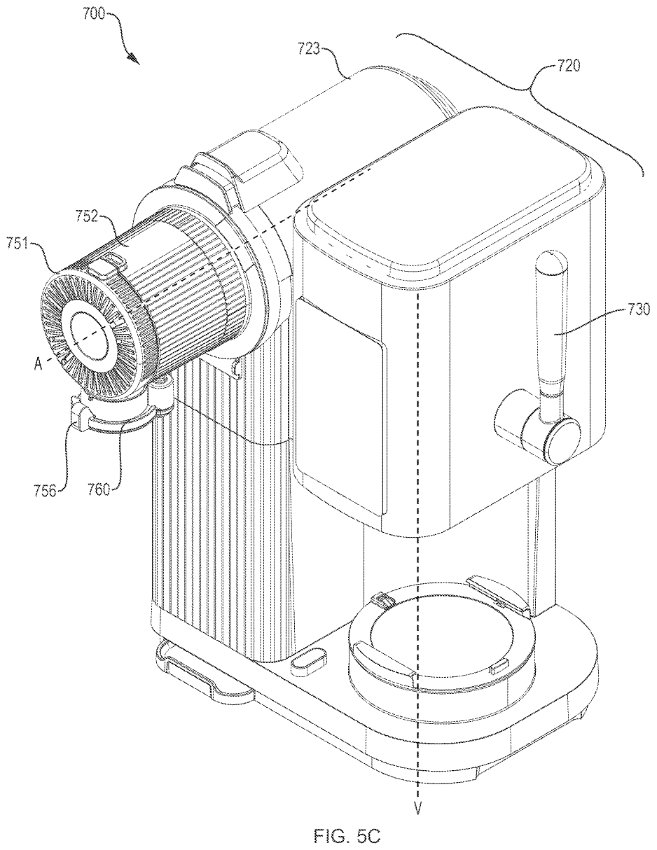

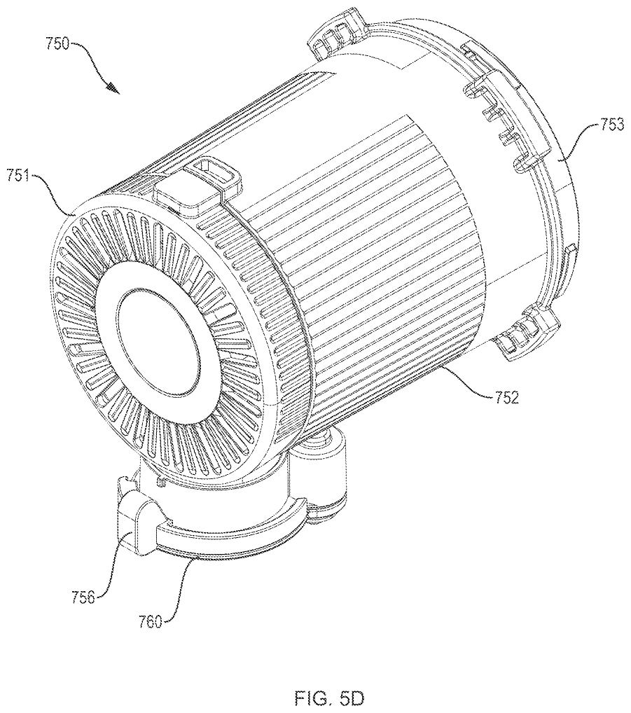

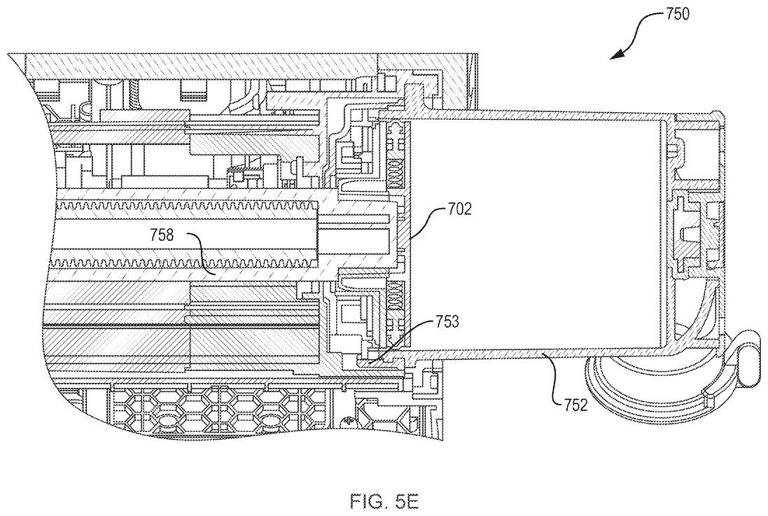

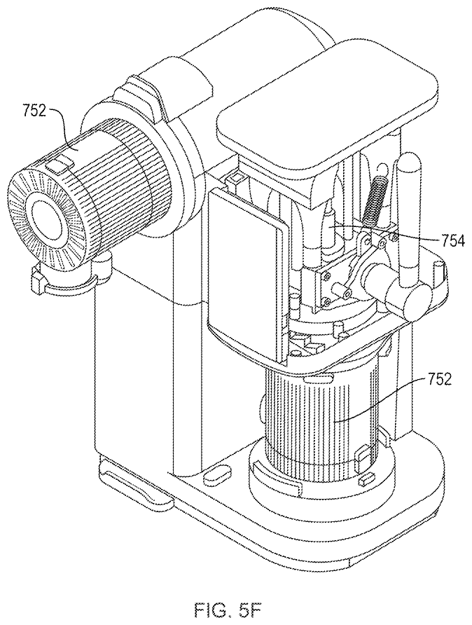

FIGS. 5A-5F illustrate another micro-puree machine 700, according to some embodiments of the disclosure. FIGS. 5A and 5B illustrate an embodiment of micro-puree machine 700 in a first configuration for processing (e.g., micro-pureeing), which may be referred to herein as a processing configuration. FIGS. 5C-5E illustrate an embodiment of micro-puree machine 700 in a first configuration for extruding, which may be referred to herein as an extruding or extrusion configuration. FIG. 5E illustrates an embodiment of micro-puree machine 700 in both processing and extruding configurations merely for illustrative purposes, as in some embodiments, the micro-puree machine 700 is not configured to perform processing and extruding concurrently.

As shown in FIGS. 5A and 5B, the micro-puree machine 700 may include a base 705 and a housing 720. The housing 720 may include a user interface (not shown) for receiving user inputs to control the micro-puree machine 700 and/or display information. In some embodiments, the micro-puree machine 700 includes a processing sub-module 721 including one or more components configured to process ingredients in a bowl 752 (e.g., bowl 352 or a variation thereof) and an extruding sub-module 723 including one or more components configured to extrude processed ingredients from the bowl 752. In a processing configuration, the bowl 752 may be coupled to the interior of an outer bowl 707 that is mounted on a processing platform 709 mounted to the base 705. The bowl 752 may be coupled to a lid 711 (e.g., lid 440 or a variation thereof) that houses a blade 713 (e.g., blade 300 or a variation thereof). The bowl 752 may include a nozzle control assembly 751 (e.g., a dial) that enables a user to control an opening or closing of a nozzle 760, a nozzle 760, and a hinged stopper 756 (e.g., plug) that can be used by a user to selectively cover the nozzle 760, or the nozzle control assembly 751. In some embodiments, the nozzle control assembly 751, the nozzle 760, and the stopper 756 may be removably attachable to the bowl 752. Using the handle 725, a user may rotate and elevate the processing bowl assembly 717 into a processing position in which the blade 713 engages with a driven shaft 754, the lid 711 couples to the micro-puree machine 700, and the blade 713 is released from the lid 711 so that the driven shaft 754 can drive the shaft 754, for example, as described in the '765 patent. By engaging the user interface (or via a remote interface wirelessly connected to a wireless interface within housing 720), the user may initiate processing of the ingredients in the bowl 752. In a processing configuration, extruding sub-module 723 may remain idle, and a cap or plug 719 may be coupled to a coupling 727, covering an interface 729 with driven shaft 754. The coupling 727 (e.g., coupling 500) also may serve as a coupling between the bowl assembly 750 (e.g., the lid 753 of the bowl assembly 750) and the micro-puree machine 700. After the processing of the ingredients, the processing bowl assembly 717 may be decoupled from the micro-puree machine 700 (e.g., from the processing sub-module 721), and de-mounted from the platform 709. The lid 711 may be removed from the outer bowl 707, and the bowl 752 may be removed from the outer bowl 707.

As shown in FIGS. 5C-5E, a lid 753 then may be mounted to the bowl 752, and the bowl 752 then may be coupled to the micro-processing machine 700 (e.g., to the extruding sub-module 723) in an extruding configuration. In the extruding configuration, the bowl 752 may be coupled to a lid 753 (e.g., lid 450 or a variant thereof) that includes a plunger 702. The combination of the bowl 752 and the lid 753 may be referred to herein as a bowl extruding assembly 750. In some embodiments, the bowl extruding assembly 750 may be configured to be installed to the micro-puree machine 700 such that the nozzle 760 faces vertically downwards when the bowl extruding assembly 750 is properly installed. The bowl extruding assembly 750 may be assembled to the housing 720 (e.g., the extruding sub-module 723) such that a central axis A of the bowl extruding assembly 750 extends perpendicular to a vertical axis V of the housing 720, as shown. The bowl extruding assembly 750 may include an outlet (e.g., nozzle 760) for extruding processed ingredients from the bowl extruding assembly 750. The micro-puree machine 700 also may include a lever 730 for manually activating a plunger 702 to extrude processed ingredients within the bowl extruding assembly 750 through the outlet. While the lever 730 is illustrated on a right side of the micro-puree machine 700 (from the front view shown in FIG. 5C), the disclosure is not so limited. The lever 730 may be on the left side of, or another location on, the micro-puree machine 700, and other components of the micro-puree machine 700 may be rearranged to accommodate the different location of the lever 730. The housing 720 may include electrical, electromagnetic, mechanical, and/or electro-mechanical components to translate a pulling down or pushing up of the lever 730 into movement of the plunger 702 within the bowl 752.

Embodiments of the housing 720 of micro-puree machine 700 may house a transmission system that includes a driven shaft 754 for engaging the blade 713, a separate driven shaft 758 for engaging the plunger 702, one or more gearing systems, and one or more position and/or drive motors for moving the driven shaft 754 and the other shaft 758 rotationally and/or axially to process the ingredients in the bowl assembly 750. For example, a drive motor may drive the rotation of the driven shaft 754 and blade (e.g., blade 300) coupled thereto, and a position motor may drive the vertical (e.g., down and up) movement of the driven shaft 754 and a blade 713. Another motor may drive the second shaft 758 and a plunger (e.g., plunger 454 or 602) attached thereto. In some embodiments, the blade 713 may be programmably controlled at the user interface by a computing system to operate at different rotational speeds and move up and down in different patterns and speeds, and for different periods of time, to make different food items. In some embodiments, the plunger 702 in the lid 753 may be programmably controlled at the user interface by a computing system to operate at different rotational speeds (although rotation is not necessary for extruding) and move up and down in different patterns and speeds, and for different periods of time. Some non-limiting examples of a transmission system and the computing system are shown as described in the '765 patent and in U.S. Pat. No. 11,882,965 to SharkNinja Operating LLC (the '965 patent), the entire contents of which are hereby incorporated by reference.

In some embodiments of the disclosure, a nozzle control assembly for a micro-puree machine (or other device for processing and/or extruding food) is provided for controlling the nozzle by which processed ingredients can be extruded from a bowl, as will now be described.

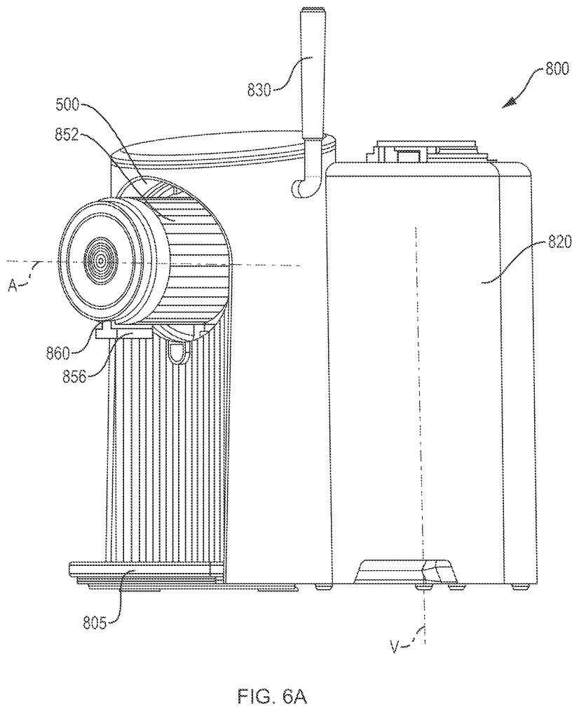

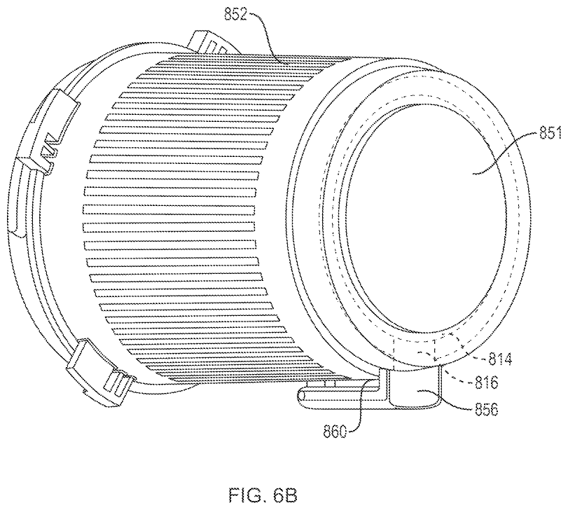

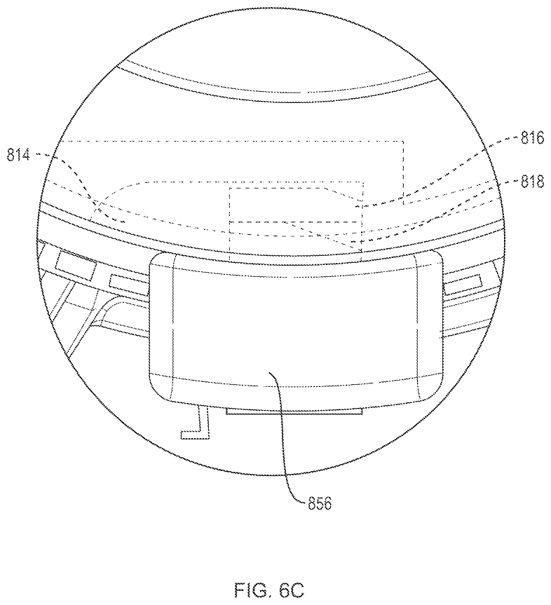

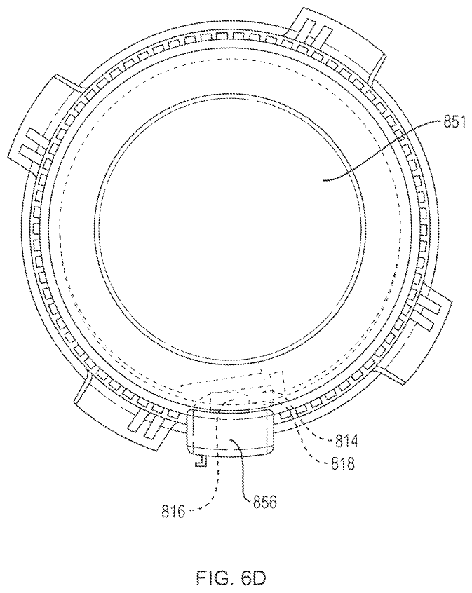

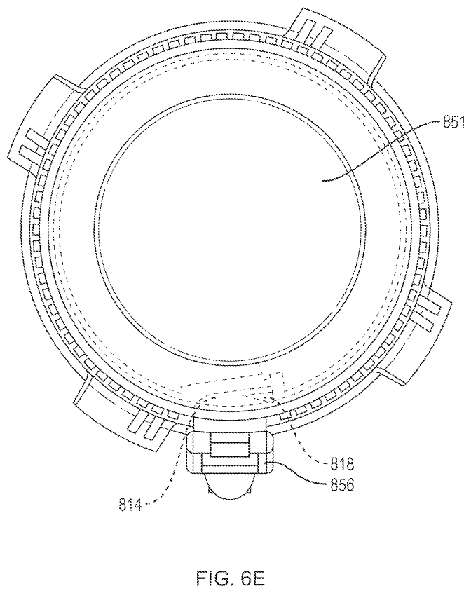

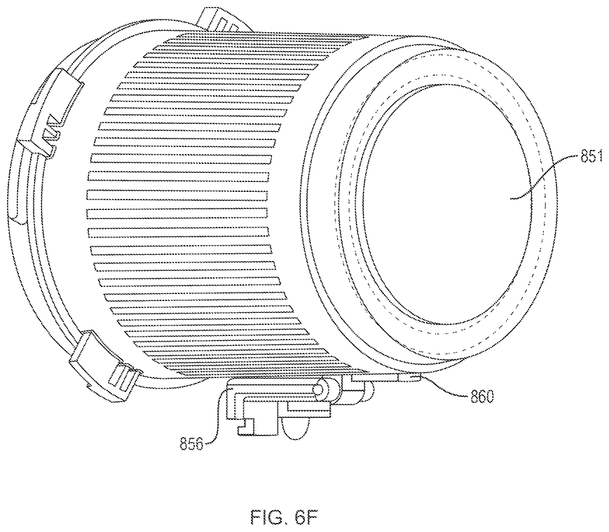

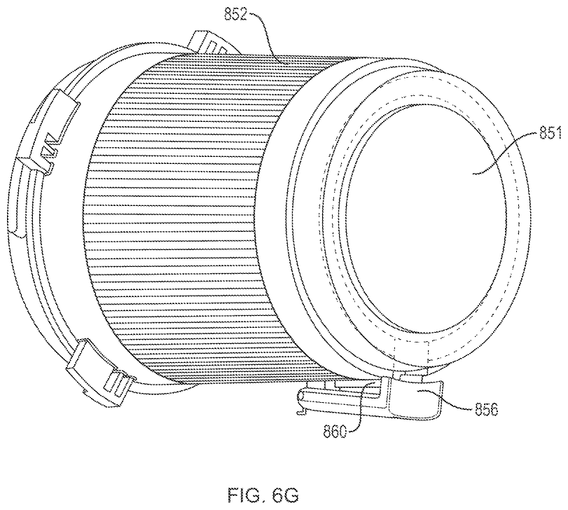

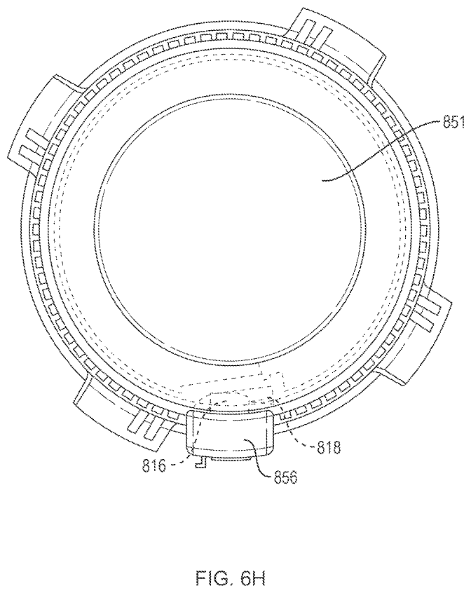

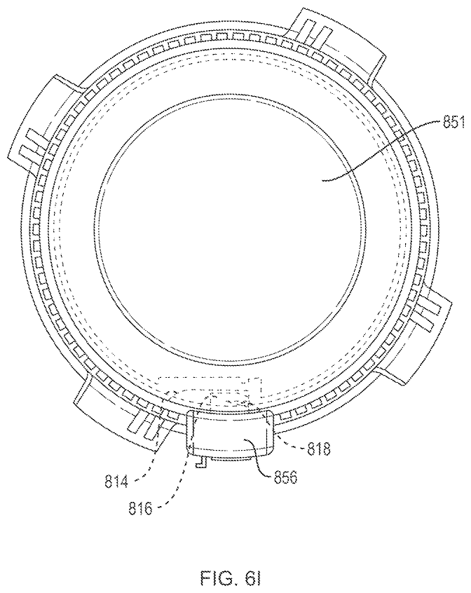

FIG. 6A illustrates another micro-puree machine 800 that performs processing and extrusion using a same driven shaft, according to some embodiments of the disclosure. While embodiments of a nozzle control assembly are described in relation to a micro-puree machine (e.g., machine 800) that performs processing and extrusion using a same driven shaft, it should be appreciated that the disclosure is not so limited. A nozzle control assembly as described herein can be implemented on a micro-puree machine in which processing is performed on a first driven shaft and extrusion is performed on a second driven shaft or on another type of device for processing food. The micro-puree machine 800 may include a base 805 and a housing 820. The housing 820 may include a user interface (not shown) for receiving user inputs to control the micro-puree machine 800 and/or display information. The micro-puree machine 800 may also include the bowl 852. The bowl 852 may be assembled to the housing 820 such that a central axis A of the bowl 852 extends perpendicular to a vertical axis V of the housing 820, as shown. However, the disclosure contemplates that the bowl 852 may be assembled to the housing 820 such that the central axis A extends at an angle of between 0 and 90° to the vertical axis V, or such that the central axis A extends parallel to the vertical axis V. The micro-puree machine 800 may also include a lever 830 for activating the plunger (e.g., plunger 602) to extrude processed ingredients within the bowl 852 through a nozzle 860. The nozzle 860 may be integrated with the bottom edge of the bowl 852 and may be coverable with a hinged stopper or plug 856. In some embodiments, the bowl 852 may be configured to be installed to the coupling (e.g., coupling 500) such that the nozzle 860 faces vertically downwards when the bowl 852 is properly installed. The nozzle 860 may be selectively located on the bowl 852 to optimize the amount of processed ingredients that can be extruded, thus minimizing the amount of yield loss after extrusion. For example, the nozzle 860 may be located near the bottom edge of the bowl 852, as shown in FIG. 6A. However, the disclosure also contemplates that the nozzle 860 may alternatively be located at a different longitudinal and/or radial position on the bowl 852.

FIG. 6B illustrates a nozzle control assembly including a rotatable dial 851 for use with the micro-puree machine 800, according to some embodiments of the disclosure. In this embodiment, the plug 856 may be biased to an open position (e.g., spring-loaded). The plug 856 may be held and locked into the closed position through engagement of an L-shaped tab 816 on the plug 856 with an internal CAM path 814 on the dial 851. The dial 851 may also be biased (e.g., spring loaded) in a first rotational direction (e.g., clockwise). To open the plug 856, the user may rotate the dial 851 in a rotational direction (e.g., counterclockwise), causing the plug 856 to be released from the CAM path 814 and sprung into the open position, as further described elsewhere herein. When the plug 856 is in the open position, the user may extrude the processed ingredients through the nozzle 860.

FIGS. 6C-6I illustrate the opening and closing of the plug 856, according to some embodiments of the disclosure. As shown in FIG. 6C, when the plug 856 is in the closed position, the tab 816 may be held within the CAM path 814 by a ramp 818. As shown in FIG. 6D, to open the plug 856, the user may rotate the dial 851 in the second rotational direction, causing the tab 816 to slide off the ramp 818 and disengage from the CAM path 814. As shown in FIG. 6E, when the tab 816 disengages from the CAM path 814, the plug 856 may automatically spring into the open position, exposing the nozzle 860 (FIG. 6F). The user may then release the dial 851 so that it springs automatically clockwise back to the home position. As shown in FIG. 6G, to close the plug 856 after extrusion of ingredients from the bowl 852, the user may manually push the plug 856 back into engagement with the nozzle 860. As shown in FIG. 6H, when the plug 856 is pushed back into engagement with the nozzle 860, the tab 816 on the plug 856 may again engage the ramp 818, causing the dial 851 to move slightly counterclockwise. As shown in FIG. 6I, once the tab 816 has moved past the ramp 818, the dial 851 may again be free to rotate clockwise, locking the plug 856 into the CAM path 814.

The disclosure further contemplates that, to prevent users from sticking their fingers into the bowl 852 through the nozzle 860 during extrusion, a cross rib (not shown) may be placed over the nozzle 860. Additionally, a magnet (not shown) in the hinged plug 856 may interact with a reed switch in the housing 820 when the plug 856 is in the open position to allow the micro-puree machine 800 to detect whether the plug 856 is open or closed. The micro-puree machine 800 may further be configured to prevent processing programs to run when the plug 856 is determined to be open.

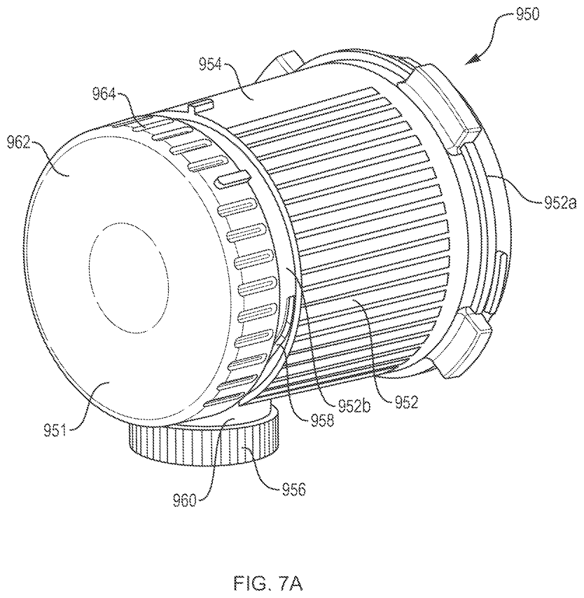

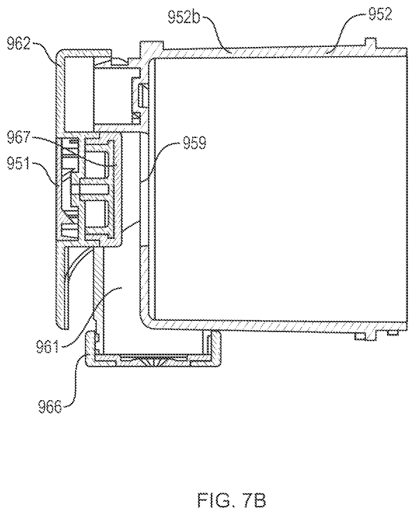

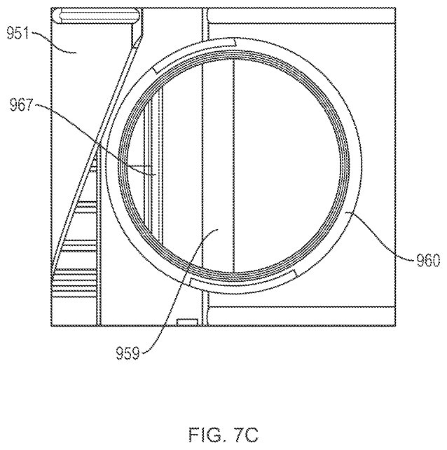

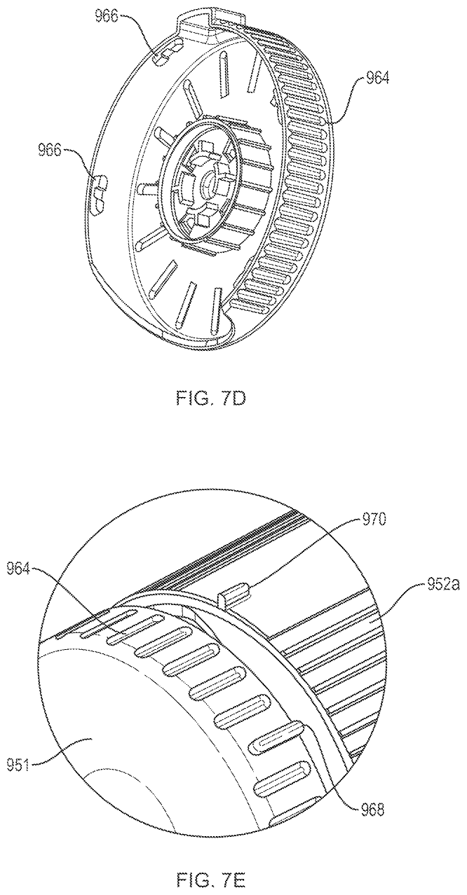

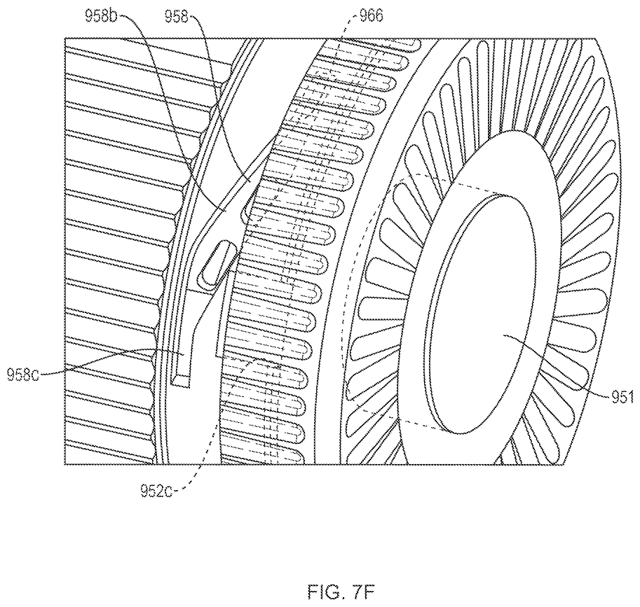

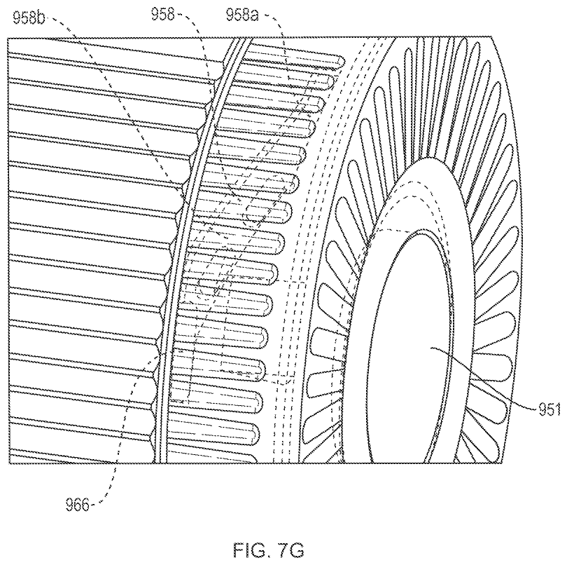

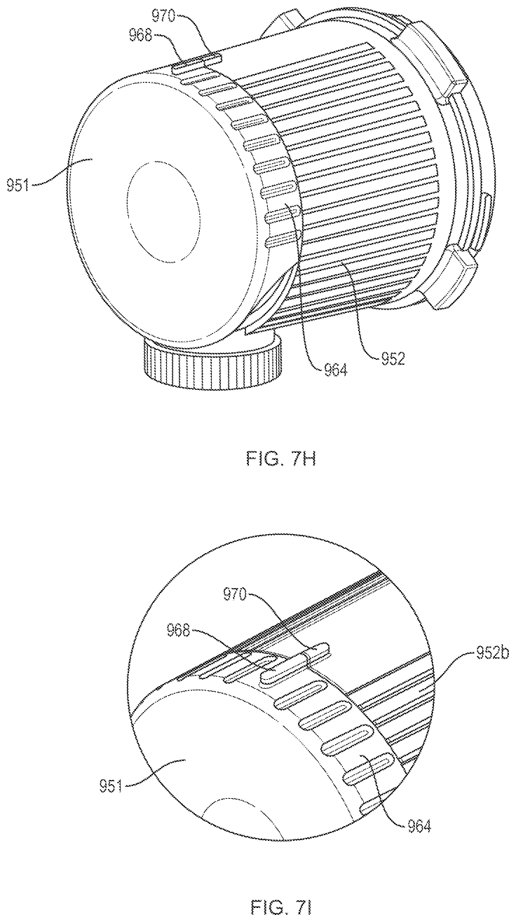

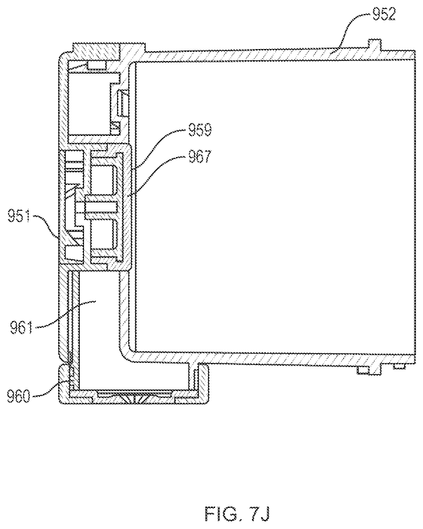

FIGS. 7A-7J illustrate another nozzle control assembly including a rotatable dial 951 for use with a micro-puree machine (e.g., micro-puree machine 700), according to some embodiments of the disclosure. FIGS. 7A-7F illustrate various aspects of the dial 951 in an open position, while FIGS. 7G-7J illustrate the dial 951 in a closed position.

As shown in FIG. 7A, a bowl assembly 950 may include a bowl 952 having a first end 952a for coupling to a lid (e.g., lid 753) and a second end 952b. A sidewall 954 may extend between the first end 952a and the second end 952b and define an interior volume of the bowl 952. The second end 952b of the bowl 952 may include a nozzle 960. An outer surface of the second end 952b may define at least one cam track 958 extending at least partially around the second end 952b, as described elsewhere herein. The dial 951 may be configured to rotate about the second end 952b of the bowl 952. The dial 951 may be permanently affixed to the second end 952b of the bowl 952 or the dial 951 may be completely removeable from the bowl 952.

The dial 951 may comprise a bottom wall 962 and a sidewall 964 extending from the bottom wall 962. The sidewall 964 may be configured to cover the second end 952b of the bowl 952 when the dial 951 is assembled to the bowl 952. As shown in FIG. 7B, the second end 952b of the bowl 952 may have at least one opening 959 in communication with the interior volume of the bowl 952 and with a channel 961 of the nozzle 960. An interior surface of the bottom wall 962 may further include a seal 967 for sealing the channel 961 when the dial 951 is in a closed position. The nozzle 960 may further include a stopper or cap 956 that can be used by a user to selectively cover a nozzle 960 when not in use. The cap 956 may include interior threading (not shown) or other coupling features that allow it to couple to the nozzle 960. As shown in FIG. 7C, when the dial 951 is in the open position, a space between the seal 967 and the opening 959 may be wide enough to allow for easy extrusion of frozen ingredients through the nozzle 960, while also narrow enough to prevent a user from inserting their fingers into the nozzle 960.

As shown in FIG. 7D, an interior surface of the sidewall 964 may have at least one engagement feature (e.g., a pin 966) for engaging and sliding along the cam track 958. The number of pins 966 may be selected to be the same as the number of cam tracks 958 on the bowl 952. For example, the number of pins 966 may be four pins 966 corresponding to four cam tracks 958, as shown. However, the disclosure contemplates that the number of pins 966 may differ from the number of cam tracks 958. As shown in FIG. 7E, an outer surface of the sidewall 964 may include a first rib 968 configured to align with a second rib 970 on the second end 952b of the bowl 952 when the dial 951 is in the closed position.

FIGS. 7F and 7G illustrate the rotation of the pins 966 into the cam track 958, according to some embodiments of the disclosure. In FIGS. 7E and 7F, the dial 951 is shown in a transparent view for ease of illustration. The cam track 958 may comprise a first portion 958a that extends substantially parallel to a bottom edge 952c of the bowl 952, a second portion 958b that extends at an angle with respect to the bottom edge 952c, and a third portion 958c that also extends substantially parallel to the bottom edge 952c. In the open position of the dial 951, the pin 966 may be positioned within the first portion 958a of the cam track 958. As the user rotates the dial 951 (e.g., counterclockwise), the pin 966 may slide within the second portion 958b into the third portion 958c of the cam track 958. A width of the third portion 958c may be selected such that an interference fit is formed between the pin 966 and the third portion 958c. As such, the dial 951 is prevented from opening during freezing and processing of the ingredients in the bowl 952 until a force is exerted on the dial 951 sufficient to move the pin 966 out of the third portion 958c.

FIGS. 7H-7J illustrate the dial 951 in the closed position, according to some embodiments of the disclosure. As shown in FIGS. 7H and 7I, when the dial 951 is in the closed position, the first rib 968 on the sidewall 964 of the dial 951 may align with the second rib 970 on the second end 952b of the bowl 952. In this way, a user may visually verify that the dial 951 is in the fully closed position and that the bowl 952 is completely sealed before freezing the ingredients within the bowl 952 or beginning the extrusion process. Furthermore, as shown in FIG. 7J, when the dial 951 is in the fully closed position, the seal 967 may close the opening 959 in the bowl 952, thus also sealing the channel 961 of the nozzle 960. The sealing of the channel 961 may prevent the inadvertent extrusion of ingredients from the bowl 952 during freezing and processing. Advantageously, a diameter of seal 967 may be selected to be sufficiently large such that an ice wall formed in the ingredients during freezing may be broken by the unsealing of the seal 967 from the opening 959.

The disclosure contemplates that, in some embodiments, the bowl from which ingredients are processed and/or extruded (e.g., bowl 352, 352′, 352″, 752, 852, 952) can be coupled vertically in an inverted orientation (e.g., downward) on a top or upward-facing surface of the housing (e.g., housing 120, 720) of a micro-puree machine (e.g., micro-puree machine 10, 700) whereby the blade (e.g., blade 300, 713) moves up and then down to creamify, process, and/or mix ingredients in the bowl. The upward-facing surface may face vertically upward or be angled in an upward direction. In some embodiments, the micro-puree machine may be configured to automatically detect a size of the bowl and, in response to the detection, extend the blade a depth and/or travel distance into the bowl based on the detected size of the bowl. This bowl-size detection would advantageously enable the micro-puree machine to process ingredients in different sized containers, such as a single serve container or larger containers.

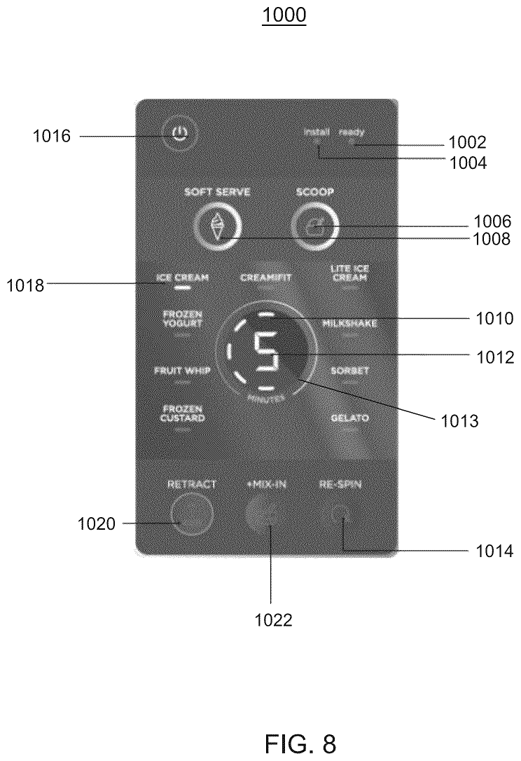

Referring now to FIG. 8, shown is a user interface 1000 for a micro-puree machine, according to some non-limiting embodiments or aspects. User interface 1000 may be implemented, at least partly, in a display on a surface of a micro-puree machine. User interface 1000 may include at least one input component (e.g., button, switch, dial, touchscreen, etc.) for receiving input from a user of the micro-puree machine. In some non-limiting embodiments or aspects, the input components of user interface 1000 may include, but are not limited to, a power input component (e.g., power button 1016), one or more operation mode input components (e.g., operation mode button 1006, operation mode button 1008), one or more program input components (e.g., program buttons 1018), and one or more special program input components, including a retract input component (e.g., retract button 1020), a mix-in input component (e.g., mix-in button 1022), a re-spin input component (e.g., re-spin button 1014), and/or the like.

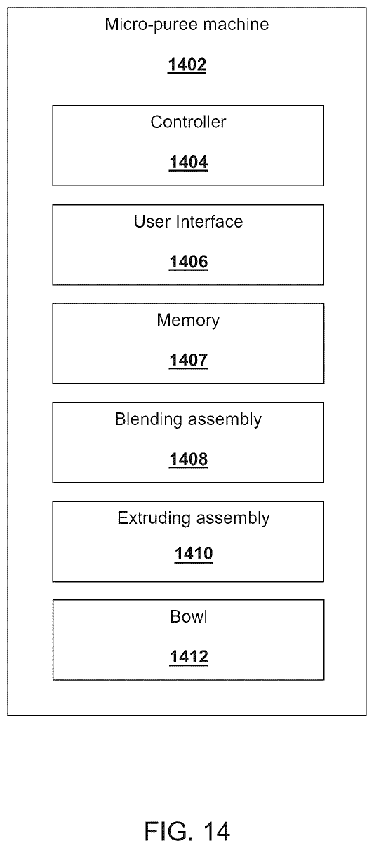

In some non-limiting embodiments or aspects, user interface 1000 may be connected to and/or controlled by a controller of the micro-puree machine (e.g., controller 1404, shown in FIG. 14). The functions executed in response to user input in user interface 1000 may be performed by controller 1404, and the feedback provided to the user via user interface 1000 may be triggered by controller 1404.

In some non-limiting embodiments or aspects, power button 1016 may be configured to receive user input to power the micro-puree machine on and off. Operation mode button 1006 may be a soft serve button (e.g., labeled “Soft Serve”), for a user to select and configure the micro-puree machine for a soft serve operational setting, which may be configured and/or suitable for preparing extrudable processed ingredients. Operation mode button 1008 may be a hard serve button (e.g., labeled “Scoop”), for a user to select and configure the micro-puree machine for a hard serve operational setting, which may be configured and/or suitable for preparing manually-scoopable processed ingredients. One or more program buttons 1018 may be configured to receive user input to carry out a preprogrammed operation (e.g., operations titled “Ice Cream”, “Creamifit”, “Lite Ice Cream”, “Frozen Yogurt”, “Milkshake”, “Fruit Whip”, “Sorbet”, “Frozen Custard”, “Gelato”, and/or the like). In some non-limiting embodiments or aspects, the one or more program buttons 1018 may be configured to execute operations with different operation parameters (e.g., time, speed, power, movement, etc.), depending on the operation mode selected by the user (e.g., using operation mode buttons 1006, 1008).

In some non-limiting embodiments or aspects, retract button 1020 may be configured to receive user input to cause a shaft (e.g., shaft 250) or blade (e.g., blade 300) to retract within and/or from a bowl (e.g., bowl 752). Additionally, or alternatively, retract button 1020 may be configured to receive user input to cause a plunger (e.g., plunger 602, plunger 702) to retract within and/or from the bowl. When retraction of a plunger, shaft, and/or blade is occurring in response to a user pressing retract button 1020, the controller may also cause the bowl to be locked in place (e.g., using one or more locking mechanisms, such as a latch) until retraction is complete, to prevent damage to the retracting components. Mix-in button 1022 may be configured to cause micro-puree machine to operate on a mixing operation mode, where mix-in ingredients (e.g., pieces of food that are not intended to be fully pulverized) added to the bowl are more gently blended into the processed contents in the bowl. Re-spin button 1014 may be configured to cause micro-puree machine to carry out a processing operation for a repeat execution, in which case the shaft and/or blade may translate more quickly through the bowl when carrying out a repeat processing operation, since it is expected that a once-processed set of ingredients will include a softer mixture.

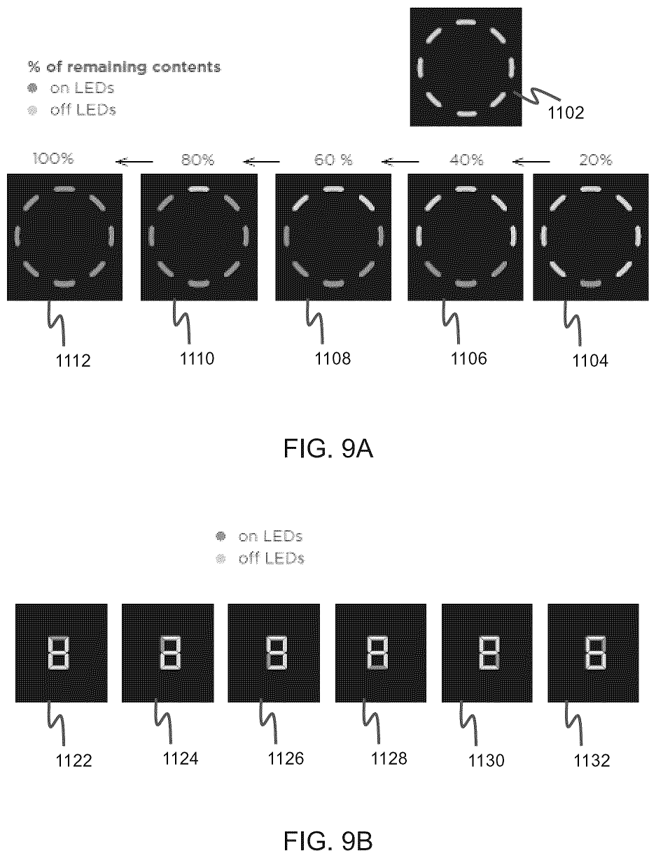

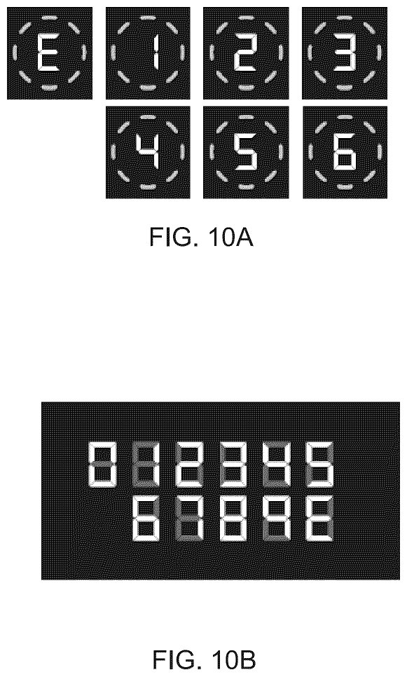

User interface 1000 may further include one or more output devices to provide output to a user of the micro-puree machine. The one or more output devices may include, but are not limited to, visual indicators (e.g., light emitting diode (LED) indicators, display screen, light indicators, etc.), aural indicators (e.g., speakers), and/or haptic indicators (e.g., vibratory devices, adjustable resistance buttons, etc.). In some non-limiting embodiments or aspects, output devices may be paired with one or more input components. For example, power button 1016 may include therein a visual indicator (e.g., an LED indicator) to light up when the micro-puree machine is powered on and turn off when the micro-puree machine is powered off. Similarly, retract button 1020, mix-in button 1022, re-spin button 1014, each operation mode button 1006, 1008, and program button 1018 may be associated with a visual indicator (e.g., an LED indicator), such as integral to the input component or positioned adjacent thereto. User interface 1000 may further include other output devices, including, but not limited to, a central display 1013, which may include a wheel indicator 1010 (e.g., comprised of a plurality of wheel segment LED indicators), a seven-segment display 1012 (e.g., a 7-segment LED display), an installation indicator 1004, a ready indicator 1002, and/or the like. For example, seven-segment display 1012 may be positioned within wheel indicator 1010. See FIGS. 9A, 10A, and 11-13 for exemplary output via wheel indicator 1010, and FIGS. 9B, 10A, and 10B for exemplary output via seven-segment display 1012.

In some non-limiting embodiments or aspects, installation indicator 1004 (e.g., an LED indicator with an associated label) may be used to convey information about an installation state of the micro-puree machine (e.g., of the bowl and/or blade for effective use of the micro-puree machine). For example, when the user is to be alerted about an installation error, such as an uninstalled bowl, the controller may activate installation indicator 1004. Similarly, ready indicator 1002 (e.g., an LED indicator with an associated label) may be used to convey information about a ready state of micro-puree machine. For example, when the micro-puree machine is powered on and ready to begin processing and/or extrusion of a frozen food product, the controller may activate ready indicator 1002.

In some non-limiting embodiments or aspects, when the micro-puree machine is plugged in from an unplugged state, the visual indicator of power button 1016 may turn on to indicate that the micro-puree machine is receiving power. For example, when plugged in, an output device (e.g., LED indicator) associated with power button 1016 may turn on for one second and then off. Moreover, other output devices of user interface 1000 may be triggered upon plugging in the micro-puree machine, such as wheel indicator 1010 and/or seven-segment display 1012. See FIG. 9B for an exemplary depiction of an animation for seven-segment display 1012, which may be triggered by plugging in the micro-puree machine. After any feedback is provided to user via one or more output devices of user interface 1000, the output devices may be returned to their default (e.g., off) state.

In some non-limiting embodiments or aspects, when the micro-puree machine is turned off, such as by a user pressing power button 1016 when the micro-puree machine is in an on state, all output devices of user interface 1000 may be turned off. This may be referred to herein as an “off state”. If the controller detects that the driven shaft (e.g., shaft 250) and/or blade (e.g., blade 300) of the micro-puree machine is not at a neutral (e.g., retracted, top-most) position, controller may cause the driven shaft and/or blade to return to the neutral position (e.g., retract, raise). When returning to the neutral position, the blade may be moved without spinning about a rotational axis. Likewise, if the controller detects that the plunger (e.g., plunger 602, plunger 702) is not at a neutral (e.g., retracted) position, controller may cause the plunger to return to the neutral position (e.g., retract).

In some non-limiting embodiments or aspects, when the micro-puree machine is turned on, such as by a user pressing power button 1016 when the micro-puree machine is in an off state, the controller may determine whether the bowl (e.g., bowl 752) is in a secured extrusion position. For example, the controller may determine whether a switch at a position of the micro-puree machine associated with extrusion is in a closed state (e.g., indicating that the switch has been closed by the attachment of the bowl in the secured extrusion position). If the controller determines that the bowl is in a secured extrusion position, the controller may set the micro-puree machine to a ready state for extrusion (e.g., an extruding ready state) and perform a series of steps associated therewith. If, however, the controller determines that the bowl is not in a secured extrusion position (e.g., the extrusion switch is not closed), then the controller may determine if the bowl is in a secured processing position (e.g., the bowl is detected at a position of the micro-puree machine associated with processing the frozen ingredients therein, such as the closing of a switch at the position). If the controller determines that the bowl (e.g., bowl 752, outer bowl 707) is not in a secured processing position, then the controller may perform a series of steps associated with a lack of installation of the bowl (e.g., an uninstalled bowl state). If the controller determines that the bowl is in a secured processing position, then the controller may determine whether a blade is installed in the bowl (e.g., in a lid of the bowl). If the controller determines that a blade is not installed in the bowl, then the controller may perform a series of steps associated with a lack of blade (e.g., a missing blade state). If, however, the controller determines that a blade is installed in the bowl, then the controller may set the micro-puree machine to a default ready state and perform a series of steps associated therewith.

When the micro-puree machine is in the uninstalled bowl state, the controller may perform a series of steps. In some non-limiting embodiments, the controller may perform one or more of: activate an output device associated with power button 1016 (e.g., illuminate or maintain illumination of an LED indicator associated therewith); deactivate one or more output devices associated with program buttons 1018 (e.g., turn off an LED indicator associated therewith) and/or deactivate one or more programs; deactivate one or more output devices associated with operation mode buttons 1006, 1008; deactivate one or more output devices associated with retract button 1020, mix-in button 1022, and/or re-spin button 1014; activate installation indicator 1004 (e.g., cause installation indicator 1004 to blink, such as on and off in 0.5 second intervals); set seven-segment display 1012 to a neutral display (e.g., “-”) or an error display (e.g., “E”); or any combination thereof. When in the uninstalled bowl state, the controller may determine if and when the bowl is in the secured extrusion state (e.g., a switch associated therewith becomes closed) and a lever (e.g., lever 730, lever 830) of the micro-puree machine is activated, in which case the controller may set the micro-puree machine to an active extruding state (e.g., an extruding running state). Additionally, or alternatively, when in the uninstalled bowl state, the controller may determine if and when the bowl is not in the secured extrusion state (e.g., a switch associated therewith is not closed) and the lever of the micro-puree machine is activated, in which case the controller may cause further error alerts to be provided to the user (e.g., additional flashing of indicators in the user interface, activation of an error beep from a speaker of the micro-puree machine, and/or the like). In some non-limiting embodiments or aspects, a generated error beep may be at 410 Hz and 70+3.5 dBA.

When the micro-puree machine is in the missing blade state, the controller may perform a series of steps. In some non-limiting embodiments, the controller may perform one or more of: activate an output device associated with power button 1016 (e.g., illuminate or maintain illumination of an LED indicator associated therewith); deactivate one or more output devices associated with program buttons 1018 (e.g., turn off an LED indicator associated therewith) and/or deactivate one or more programs (e.g., disable and/or prevent activation thereof); deactivate one or more output devices associated with operation mode buttons 1006, 1008; deactivate one or more output devices associated with retract button 1020, mix-in button 1022, and/or re-spin button 1014; activate installation indicator 1004 (e.g., cause installation indicator 1004 to blink, such as on and off in 0.5 second intervals); set seven-segment display 1012 to a neutral display (e.g., “-”) or an error display (e.g., “E”); or any combination thereof. When in the missing blade state, the controller may determine if and when the bowl is in the secured extrusion state (e.g., a switch associated therewith becomes closed) and a lever (e.g., lever 730, lever 830) of the micro-puree machine is activated, in which case the controller may set the micro-puree machine to an active extruding state (e.g., an extruding running state). Additionally, or alternatively, when in the missing blade state, the controller may determine if and when the bowl is not in the secured extrusion state (e.g., a switch associated therewith is not closed) and the lever of the micro-puree machine is activated, in which case the controller may cause further error alerts to be provided to the user (e.g., additional flashing of indicators in the user interface, activation of an error beep from a speaker of the micro-puree machine, and/or the like). In some non-limiting embodiments or aspects, a generated error beep may be at 410 Hz and 70+3.5 dBA, at intervals (e.g., 0.4 seconds on, 0.2 seconds off, for two or more times).

When the micro-puree machine is in the ready state for extrusion, the controller may perform a series of steps. In some non-limiting embodiments, the controller may determine if the blade is installed or the bowl (e.g., bowl 752, outer bowl 707) is installed at a secured processing position, and if either is true, the controller may switch the micro-puree machine to a default ready state. In some non-limiting embodiments, and when in the extruding ready state, the controller may perform one or more of: activate an output device associated with power button 1016 (e.g., illuminate or maintain illumination of an LED indicator associated therewith); activate wheel indicator 1010 (e.g., illuminate one or more LED indicators thereof); activate ready indicator 1002 (e.g., illuminate ready indicator 1002); deactivate seven-segment display 1012; deactivate a motor that drives a processing blade; deactivate one or more output devices associated with program buttons 1018 and/or deactivate one or more programs; deactivate one or more output devices associated with operation mode buttons 1006, 1008; deactivate one or more output devices associated with retract button 1020, mix-in button 1022, and/or re-spin button 1014; or any combination thereof. While in the ready state for extrusion, the controller may monitor the activation (e.g., pushing, pulling, etc.) and release of a lever (e.g., lever 730, lever 830). In response to detection of the lever being activated, the controller may set the micro-puree machine to an active extruding state. In response to detection of the lever being released, the controller may cause an output device associated with retract button 1020 to activate (e.g., illuminate an LED indicator, such as blinking in 0.75 second intervals) and may retain the micro-puree machine in a ready state for extrusion.

When the micro-puree machine is in the default ready state, the controller may perform a series of steps. In some non-limiting embodiments, the controller may perform one or more of: activate an output device associated with power button 1016 (e.g., illuminate or maintain illumination of an LED indicator associated therewith); activate or deactivate one or more output devices associated with program buttons 1018 (e.g., turn off an LED indicator associated therewith); activate one or more output devices associated with operation mode buttons 1006, 1008 (e.g., cause LED indicators associate therewith to blink, such as at 0.75 second intervals); activate one or more output devices associated with retract button 1020, mix-in button 1022, and/or re-spin button 1014; activate installation indicator 1004 (e.g., illuminate installation indicator 1004); set seven-segment display 1012 to a neutral display (e.g., “-”); or any combination thereof. When in the default ready state, the controller may trigger one or more actions in response to the selection of operation mode button 1006 or operation mode button 1008. In response to selection of operation mode button 1006 or operation mode button 1008, the controller may perform one or more of: activate one or more output devices associated with program buttons 1018 that are associated with the selected operation mode button 1006 or the selected operation mode button 1008; activate ready indicator 1002; or any combination thereof. When the user selects a program button 1018, the controller may then set the micro-puree machine to a food processing state. If the user selects a special program button, such as mix-in button 1022, re-spin button 1014, and/or the like, the controller may set the micro-puree machine to a special processing state.

When the micro-puree machine is in the default ready state, the controller may determine if and when the bowl is in the secured extrusion state (e.g., a switch associated therewith becomes closed) and a lever (e.g., lever 730, lever 830) of the micro-puree machine is activated, in which case the controller may set the micro-puree machine to an active extruding state (e.g., an extruding running state). Additionally, or alternatively, when in the default ready state, the controller may determine if and when the bowl is not in the secured extrusion state (e.g., a switch associated therewith is not closed) and the lever of the micro-puree machine is activated, in which case the controller may cause further error alerts to be provided to the user (e.g., additional flashing of indicators in the user interface, activation of an error beep from a speaker of the micro-puree machine, and/or the like).

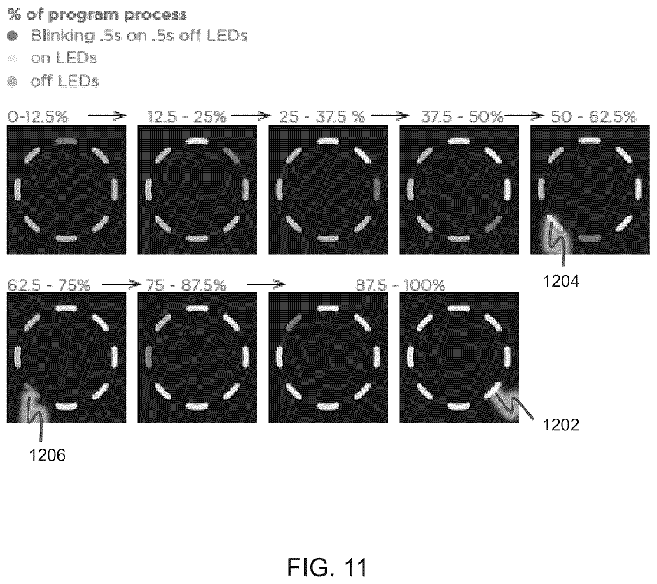

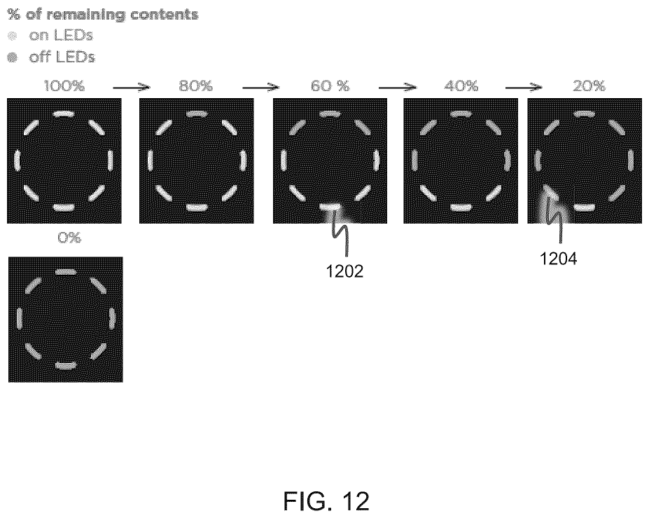

When the micro-puree machine is in the active extruding state, the controller may perform a series of steps. In some non-limiting embodiments or aspects, the controller may perform one or more of: activate an output device associated with power button 1016 (e.g., illuminate or maintain illumination of an LED indicator associated therewith); activate wheel indicator 1010 (e.g., illuminate one or more LED indicators thereof, such as in a sequence shown in FIG. 9A, FIG. 11, or FIG. 12); deactivate an output device associated with retract button 1020 and/or deactivating retract button 1020 (e.g., while the plunger is in motion, for the entire extruding process, etc.); activate one or more output devices of user interface 1000, such as seven-segment display 1012 (e.g., blinking at least one segment of seven-segment display 1012 in 0.75 second intervals); deactivate one or more output devices associated with program buttons 1018 (e.g., turn off an LED indicator associated therewith) and/or deactivate program buttons 1018; deactivate one or more output devices associated with operation mode buttons 1006, 1008 and/or deactivate operation mode buttons 1006, 1008; deactivate one or more output devices associated with mix-in button 1022 and/or re-spin button 1014, and/or deactivate mix-in button 1022 and/or re-spin button 1014; or any combination thereof.

Further, when the micro-puree machine is in the active extruding state, the controller may monitor the position of the lever and/or the progress of the plunger to determine when the extrusion process is proceeding, when the extrusion process is paused, when the extrusion process is completed, and/or the like. The controller may permit and cause retraction of the plunger in response to activation of the retract button 1020, if the extrusion process is paused (e.g., the lever is released partway through the extrusion process). When the retract button 1020 is activated, the controller may set the micro-puree machine to an extruding completion state. Additionally, or alternatively, when the lever is released during extrusion, the controller may automatically retract the plunger a short distance (e.g., 4 mm, at maximum retract speed) and then pause. The controller may set the micro-puree machine to an extruding completion state when the controller detects that the plunger has extended to the maximum possible extension/distance within the bowl.

When the micro-puree machine is in the extruding completion state, the controller may perform a series of steps. In some non-limiting embodiments or aspects, the controller may perform one or more of: activate an output device associated with power button 1016 (e.g., illuminate or maintain illumination of an LED indicator associated therewith); activate one or more output devices of user interface 1000 and/or micro-puree machine to indicate that the extruding process has been completed (e.g., generate beeps from a speaker, in a pattern of three cycles of intervals, including an on-interval followed by an off-interval, each interval at 0.5 seconds in length, and set to 4200+420 Hz and 70+3.5 dBA); retract the plunger (e.g., immediately or in response to an elapsed period of time without further user input, such as a 5 minute delay); activate wheel indicator 1010 (e.g., illuminate one or more LED indicators thereof, such as in a sequence shown in FIG. 9A, FIG. 11, or FIG. 12); deactivate an output device associated with retract button 1020 and/or deactivating retract button 1020 (e.g., while the plunger is in motion); deactivate one or more output devices associated with program buttons 1018 (e.g., turn off an LED indicator associated therewith) and/or deactivate program buttons 1018; deactivate one or more output devices associated with operation mode buttons 1006, 1008 and/or deactivate operation mode buttons 1006, 1008; deactivate one or more output devices associated with mix-in button 1022 and/or re-spin button 1014, and/or deactivate mix-in button 1022 and/or re-spin button 1014; or any combination thereof. If the user activates the lever when the micro-puree machine is in the extruding completion state, the controller may, in response, cause an output device of user interface 1000 and/or micro-puree machine to activate, so as to alert the user (e.g., activating a speaker to cause an error beep, such as two cycles of intervals, including an on-interval followed by an off-interval, at 410 Hz and 70+3.5 dBA).

When the micro-puree machine is in the food processing state, the controller may perform a series of steps. In some non-limiting embodiments or aspects, the controller may perform one or more of: activate a drive motor, shaft, and/or blade to process frozen food contained in an installed bowl, according to parameters determined based on the selected program and selected operation mode; activate an output device (e.g., turning on or maintaining illumination of an LED indicator) associated with a selected program button 1018; activate an output device (e.g., turning on or maintaining illumination of an LED indicator) associated with a selected operation mode button 1006, 1008; deactivate all output devices associated with a non-selected program button 1018; deactivate all output devices associated with a non-selected operation mode button 1006, 1008; activate wheel indicator 1010 (e.g., illuminate one or more LED indicators thereof, such as in a sequence shown in FIG. 9A, FIG. 11, or FIG. 12); activate seven-segment display (e.g., displaying a number of minutes remaining for the selected program and updating periodically during processing; see, e.g., FIG. 10A or 10B); or any combination thereof. If the bowl is removed during the food processing state, the controller may set the micro-puree machine to a premature release state. If power button 1016 and/or a program button 1018 is pressed during the food processing state, the controller may set the micro-puree machine to an interrupt state. If the user activates the lever during the food processing state, the controller may cause one or more output devices to communicate an alert to the user (e.g., generating error beeps from a speaker of the micro-puree machine, such as two cycles of intervals, including an on-interval and an off-interval, at 410 Hz and 70+3.5 dBA).

When the micro-puree machine is in the premature release state, the controller may perform a series of steps. In some non-limiting embodiments or aspects, the controller may perform one or more of: activate an output device associated with power button 1016 (e.g., illuminate or maintain illumination of an LED indicator associated therewith); deactivate a drive motor, shaft, and/or blade; deactivating one or more output devices associated with other interface buttons, including operation mode buttons 1006, 1008, program buttons 1018, retract button 1020, mix-in button 1022, and/or re-spin button 1014; activate one or more output devices associated with program buttons 1018; activate seven-segment display 1012 to neutral display (e.g., “a”) or error display (e.g., “E”) (e.g., in a constant or intermittent illumination, such as cycling on and off in 0.5 second intervals); retract the drive shaft to the topmost position (e.g., with or without rotation of the blade); generate one or more alerts from one or more output devices of user interface 1000 or the micro-puree machine (e.g., emitting a beep from a speaker, including repeatedly, at 410 Hz and 70+3.5dBA); or any combination thereof. After entering the premature release state, the controller may proceed (e.g., after a time delay and/or in response to user input) to set the micro-puree machine to the uninstalled bowl state.

When the micro-puree machine is in the interrupt state, the controller may perform a series of steps. In some non-limiting embodiments or aspects, the controller may perform one or more of: activate an output device associated with power button 1016 (e.g., illuminate or maintain illumination of an LED indicator associated therewith); deactivate a drive motor, shaft, and/or blade; deactivating one or more output devices associated with other interface buttons, including operation mode buttons 1006, 1008, program buttons 1018, retract button 1020, mix-in button 1022, and/or re-spin button 1014; activate one or more output devices associated with program buttons 1018; activate seven-segment display 1012 to neutral display (e.g., “a”) or error display (e.g., “E”) (e.g., in a constant or intermittent illumination, such as cycling on and off in 0.5 second intervals); retract the drive shaft to the topmost position (e.g., with or without rotation of the blade); generate one or more alerts from one or more output devices of user interface 1000 or the micro-puree machine (e.g., emitting a beep from a speaker, including repeatedly, at 410 Hz and 70+3.5dBA); or any combination thereof. After entering the interrupt state, the controller may proceed (e.g., after a time delay and/or in response to user input) to set the micro-puree machine to the processing completion state.

When the micro-puree machine is in the processing completion state, the controller may perform a series of steps. In some non-limiting embodiments or aspects, the controller may perform one or more of: activate an output device associated with power button 1016 (e.g., illuminate or maintain illumination of an LED indicator associated therewith); activating seven-segment display 1012 (e.g., to display “0”, such as for a period of time after completion, such as 180 seconds); generate user feedback that the processing is complete via one or more output devices (e.g., generate a beep from a speaker, such as at least one cycle of intervals, including an on-interval followed by an off-interval, at 0.5 seconds per interval, at 4200 Hz and 70+3.5 dBA); deactivate one or more output devices associated with one or more program buttons 1018 and/or deactivate one or more program buttons 1018; activate an output device associated with ready indicator 1002 (e.g., illuminate an LED indicator associated therewith); or any combination thereof. If the controller detects disconnection of the bowl from a processing position during the processing completion state, then the controller may set the micro-puree machine to an uninstalled bowl state. If the user activates power button 1016 during the processing completion state, the controller may set the micro-puree machine to an off state. Additionally, or alternatively, if a time period elapses (e.g., a 180 second delay) during the processing completion state and no input is received in the time period, the controller may set the micro-puree machine to an off state. If the user activates the lever when the micro-puree machine is in the extruding completion state, the controller may, in response, cause an output device of user interface 1000 and/or micro-puree machine to activate, so as to alert the user (e.g., activating a speaker to cause an error beep, such as two cycles of intervals, including an on-interval followed by an off-interval, at 410 Hz and 70+3.5 dBA).

When the micro-puree machine is in the special processing state, the controller may perform a series of steps. In some non-limiting embodiments or aspects, the controller may perform one or more of: activating a drive motor, shaft, and/or blade of the micro-puree machine to carry out processing of the frozen food ingredients in the bowl according to the special program parameters (e.g., a mix-in function, a re-spin function, and/or the like); activate an output device (e.g., turning on or maintaining illumination of an LED indicator) associated with a selected special program button (e.g., mix-in button 1022, re-spin button 1014); deactivate all output devices associated with a non-selected program button 1018; deactivate all output devices associated with a non-selected operation mode button 1006, 1008; activate wheel indicator 1010 (e.g., illuminate one or more LED indicators thereof, such as in a sequence shown in FIG. 9A, FIG. 11, or FIG. 12); activate seven-segment display (e.g., displaying a number of minutes remaining for the selected program and updating periodically during processing; see, e.g., FIG. 10A or 10B); or any combination thereof. If the bowl is removed during the special processing state, the controller may set the micro-puree machine to a premature release state. If power button 1016 and/or a program button 1018 is pressed during the special processing state, the controller may set the micro-puree machine to an interrupt state. If the user activates the lever during the special processing state, the controller may cause one or more output devices to communicate an alert to the user (e.g., generating error beeps from a speaker of the micro-puree machine, such as two cycles of intervals, including an on-interval and an off-interval, at 410 Hz and 70+3.5 dBA).

In some non-limiting embodiments or aspects, the controller may be configured to detect a number of exceptions (e.g., errors, handled conditions) during operation of the micro-puree machine. When an exception is detected, the controller may output information about the exception using an output device of the user interface 1000. For example, the controller may update seven-segment display 1012 to display information about the exception, such as by illuminating the letter “E” for “error” or “exception”, followed by illuminating a number identifying the type of exception. See FIG. 10A for use of central display 1013, including seven-segment display 1012, to convey information about a detected exception.

In some non-limiting embodiments or aspects, the controller may detect a timeout exception. For example, if the unit is in a powered on state and no input is received for a period of time (e.g., 10 minutes), the controller may set the micro-puree machine to a powered off state. By way of further example, the controller may start a timer function in response to receiving a user input and may compare the value of the timer to a predetermined threshold (e.g., 10 minutes). In response to the value of the timer satisfying the predetermined threshold, the controller may set the micro-puree machine to a powered off state.

In some non-limiting embodiments or aspects, the controller may detect a load limit exception. Load limits may include software overloads, mechanical overloads (e.g., rubber cushion overloads, slip clutch overloads), and/or the like. For example, the controller may be configured to monitor operational software to detect when demands on the software (e.g., processor inputs, memory, etc.) exceed a predetermined threshold. By way of another example, the controller may include one or more sensors (e.g., vibration sensors, temperature sensors, rotational sensors, etc.) to detect dangerous operation conditions associated with overloading mechanical parts of the micro-puree machine. In response to detecting a load limit exception, the controller may perform one or more of: activate seven-segment display 1012 (e.g., to display an error code “E” for an interval, which may blink in a cycle of intervals, including an on-interval followed by an off-interval, at 0.8 seconds per interval; an error code number interval may be inserted between the on-interval of the “E” and the off-interval, such as an error code number, such as “0”, that is displayed for 0.8 seconds); activate one or more output devices of user interface 1000 and/or micro-puree machine to alert the user (e.g., generating beeps from a speaker in three cycles of intervals, including an on-interval followed by an off-interval, at 0.4 seconds on and 0.2 seconds off, at 410 Hz and 70+3.5 dBA); retract plunger at least partly; retract shaft and/or blade at least partly; set the micro-puree machine to a ready state (e.g., a ready state for extrusion, a default ready state, etc.); or any combination thereof. If repeat load limit exceptions are detected, the controller may require the user to remove the bowl from the micro-puree machine and reinstall the bowl before setting the micro-puree machine to a ready state. In response to the load limit exception being resolved, the controller may set the micro-puree machine to a non-exception state, such as a ready state.

In some non-limiting embodiments or aspects, the controller may detect a motor stall exception. For example, the drive motor for the plunger and/or the shaft and blade may stall (e.g., cease rotation or lose power). By way of further example, the controller may use a rotational sensor to detect motor rotational velocity (e.g., in revolutions per minute (RPM)) and compare the rotational velocity to a predetermined threshold (e.g., 250 RPM, 500 RPM, 1500 RPM). If the detected rotational velocity is below or at the predetermined threshold for a period of time (e.g., 3 seconds), the controller may execute mitigative actions. For example, the controller may perform one or more of: disable one or more motors; disable one or more input components of user interface 1000 and/or output devices associated therewith; activate one or more output devices of user interface 1000 (e.g., to blink on and off in unison); activate seven-segment display 1012 (e.g., to display an error code “E” for an interval, which may blink in a cycle of intervals, including an on-interval followed by an off-interval, at 0.8 seconds on and 0.4 seconds off; an error code number interval may be inserted between the on-interval of the “E” and the off-interval, such as an error code number, such as “1”, that is displayed for 0.8 seconds); retracting the plunger; retracting the shaft and/or blade (e.g., with or without spinning the blade); or any combination thereof. In response to the motor stall exception being resolved, the controller may set the micro-puree machine to a non-exception state, such as a ready state. The user may be required to unplug the micro-puree machine to resolve the motor stall exception, which may reset and cancel the mitigative actions. In some non-limiting embodiments or aspects, disengaging bowl interlocks and allowing the micro-puree machine to timeout and shutoff automatically may not resolve the exception.

In some non-limiting embodiments or aspects, the controller may detect a runtime exceedance exception. For example, the controller may use a timer to determine an actual runtime of the micro-puree machine to perform a selected processing program or extrusion. Actual runtime may include a total runtime for a selected program without interlock disengagement or unplugging the micro-puree machine, and may not include paddle retracking as part of the calculated runtime. Motor stop time for greater than a threshold stop time (e.g., 10 seconds) may be considered a permanent stoppage of time. If the controller determines that the actual runtime meets and/or exceeds a predetermined threshold (e.g., set as 1.5x a predetermined runtime for the selected processing program or extrusion, +30 second buffer), the controller may execute mitigative actions. For example, the controller may perform one or more of: disable one or more motors; disable one or more input components of user interface 1000 and/or output devices associated therewith; activate one or more output devices of user interface 1000 (e.g., to blink on and off in unison); activate seven-segment display 1012 (e.g., to display an error code “E” for an interval, which may blink in a cycle of intervals, including an on-interval followed by an off-interval, at 0.8 seconds on and 0.4 seconds off; an error code number interval may be inserted between the on-interval of the “E” and the off-interval, such as an error code number, such as “2”, that is displayed for 0.8 seconds); retracting the plunger; retracting the shaft and/or blade (e.g., with or without spinning the blade); or any combination thereof. In response to the runtime exceedance exception being resolved, the controller may set the micro-puree machine to a non-exception state, such as a ready state. The user may be required to unplug the micro-puree machine to resolve the runtime exceedance exception, which may reset and cancel the mitigative actions. In some non-limiting embodiments or aspects, disengaging bowl interlocks and allowing the micro-puree machine to timeout and shutoff automatically may not resolve the exception.

In some non-limiting embodiments or aspects, the controller may detect a bowl removal exception. For example, the controller may determine whether a bowl is attached to the micro-puree machine at one or more positions (e.g., an extrusion position, a processing position, etc.) based on the closure of one or more interlock switches. If the controller detects an opening of an interlock switch due to the removal of a bowl, the controller may determine that the bowl has been removed. In response, the controller may disable all motors, disable all buttons, activate all indicators in the user interface 1000, and retract the plunger and/or drive shaft until the bowl removal exception is resolved. The controller may further activate seven-segment display 1012 (e.g., to display an error code “E” for an interval, which may blink in a cycle of intervals, including an on-interval followed by an off-interval, at 0.8 seconds on and 0.4 seconds off; an error code number interval may be inserted between the on-interval of the “E” and the off-interval, such as an error code number, such as “3”, that is displayed for 0.8 seconds). To resolve the bowl removal exception, the user may be required to reinstall the bowl to the position where removal was detected, thereby closing the interlock switch.

In some non-limiting embodiments or aspects, the controller may detect an abnormal retraction exception. For example, the controller may monitor the effort required to retract the plunger and/or shaft (e.g., using a power draw sensor, a resistance sensor, and/or the like) and determine that retraction is being inhibited. Additionally, or alternatively, the controller may activate a timer when retraction begins and determine an abnormal retraction to have occurred in response to the retraction time exceeding a predetermined threshold (e.g., 10 seconds for a plunger, 6 minutes for a drive shaft for food processing). In response to detection of the abnormal retraction exception, the controller may execute mitigative actions. For example, the controller may perform one or more of: disable one or more motors; disable one or more input components of user interface 1000 and/or output devices associated therewith; activate one or more output devices of user interface 1000 (e.g., to blink on and off in unison); activate seven-segment display 1012 (e.g., to display an error code “E” for an interval, which may blink in a cycle of intervals, including an on-interval followed by an off-interval, at 0.8 seconds on and 0.4 seconds off; an error code number interval may be inserted between the on-interval of the “E” and the off-interval, such as an error code number, such as “4”, that is displayed for 0.8 seconds); or any combination thereof. In response to the abnormal retract exception being resolved, the controller may set the micro-puree machine to a non-exception state, such as a ready state. The user may be required to unplug the micro-puree machine to resolve the abnormal retraction exception, which may reset and cancel the mitigative actions. In some non-limiting embodiments or aspects, disengaging bowl interlocks and allowing the micro-puree machine to timeout and shutoff automatically may not resolve the exception.

In some non-limiting embodiments or aspects, the controller may detect a hardware load limit exception. For example, the controller may monitor one or more hardware components of the micro-puree machine to determine when the hardware is being overloaded. In response to detected hardware overload, the controller may execute mitigative actions. For example, the controller may perform one or more of: disable one or more motors; disable one or more input components of user interface 1000 and/or output devices associated therewith; activate seven-segment display 1012 (e.g., to display an error code “E” for an interval, which may blink in a cycle of intervals, including an on-interval followed by an off-interval, at 0.8 seconds on and 0.4 seconds off; an error code number interval may be inserted between the on-interval of the “E” and the off-interval, such as an error code number, such as “8”, that is displayed for 0.8 seconds); activate one or more output devices of user interface 1000 and/or micro-puree machine to alert the user (e.g., generating beeps from a speaker in three cycles of intervals, including an on-interval followed by an off-interval, at 0.4 seconds on and 0.2 seconds off, at 410 Hz and 70+3.5 dBA); or any combination thereof.

In some non-limiting embodiments or aspects, the controller may control operation of the micro-puree machine for extrusion (e.g., ejecting processed frozen ingredients) and processing (e.g., blending frozen ingredients, which may then be extruded). Each processing operation may be controlled according to one or more operation parameters, including, but not limited to, speed of rotation (e.g., of motor, shaft, blade, etc.), motor power, speed of translation (e.g., of shaft and/or blade into bowl), time of processing, blade path (e.g., direction and/or length) through ingredients, number of passes of blade through ingredients, pulse instructions, pause instructions, rate of withdrawal of shaft and/or blade, maximum threshold power draw, maximum threshold resistance, maximum and/or expected processing time, and/or the like. Each extrusion operation may be controlled according to one or more extrusion parameters, including, but not limited to, speed of extrusion (e.g., of motor, shaft, plunger, etc.)., motor power, time of extrusion, plunger path (e.g., direction and/or length) through ingredients, number of passes of plunger through ingredients, pulse instructions, pause instructions, rate of withdrawal of shaft and/or plunger, maximum threshold power draw, maximum threshold resistance, maximum and/or expected extrusion time, and/or the like. Operation parameters for a processing operation may be referred to as processing parameters. Operation parameters for an extrusion operation may be referred to as extrusion parameters.

In some non-limiting embodiments or aspects, the controller may determine different sets of operation parameters based at least in part on: a user-selected operation mode button 1006, 1008; a user-selected program button 1018; a user-selected special program button, such as mix-in button 1022, re-spin button 1014, and/or the like. For example, when user selects an operation mode button 1006, 1008, the controller may determine the same or different operation parameters associated with the program buttons 1018. By way of further example, if the user selects operation mode button 1006 (e.g., associated with “Soft Serve”), the controller may vary the operation parameters associated with one or more program button 1018, such as to ensure the end product aligns with the selected operation mode button 1006 (e.g., a softer, less compacted and blended food product). In such an illustration, a program button 1018 associated with the label “Ice Cream” may have different operation parameters when the user has selected operation mode button 1006 than the same program button 1018 if the user had selected operation mode button 1008. For example, the controller may determine (e.g., based on stored operation parameter records in memory) a set of operation parameter records for the selected operation mode button 1006 (e.g., “Soft Serve”) and program button 1018 (e.g., “Ice Cream”) that is more likely to yield a softer end product (e.g., longer processing time, faster rotation, more power, slower translation, more paths through ingredients, and/or the like) compared to the same program button 1018 (e.g., “Ice Cream”) if the user had selected another operation mode button 1008 (e.g., “Scoop”) (e.g., less processing time, slower rotation, slower translation, fewer paths through ingredients, and/or the like).

In some non-limiting embodiments or aspects, the controller may alter operation parameters for program buttons 1018 based on selected operation mode buttons 1006, 1008 in a fixed and/or dynamic manner. For example, a memory of the micro-puree machine may store a record of operation parameters for each combination of operation mode button 1006, 1008 and program button 1018. To illustrate, if the user selects a first operation mode button 1006 associated with “Soft Serve” and selects a program button 1108 associated with “Ice Cream”, the controller may retrieve a record from memory associated with the combination of “Soft Serve” and “Ice Cream” to determine the operation parameters. Additionally, or alternatively, a memory of the micro-puree machine may store a record of operation parameters for each program button 1018 and may apply an offset to the operation parameters based on a selected operation mode button 1006, 1008. To illustrate, if the user selects a first operation mode button 1006 associated with “Soft Serve” and selects a program button 1108 associated with “Ice Cream”, the controller may retrieve a record from memory associated with “Ice Cream” including default operation parameters and optionally apply an offset associated with “Soft Serve” (e.g., a value of increased processing time, faster rotation, more power, slower rotation, more paths through ingredients, etc.). Additionally, or alternatively, a memory of the micro-puree machine may store a record of operation parameters for each operation mode button 1006, 1008 and may apply an offset to the operation parameters based on a selected program button 1018. To illustrate, if the user selects a first operation mode button 1006 associated with “Soft Serve” and selects a program button 1108 associated with “Ice Cream”, the controller may retrieve a record from memory associated with “Soft Serve” including default operation parameters and optionally apply an offset associated with “Ice Cream” (e.g., a value of increased processing time, faster rotation, more power, slower rotation, more paths through ingredients, etc.). It will be appreciated that the same alteration of operation parameters may be carried out for special program buttons, including mix-in button 1022 and re-spin button 1014. In this manner, operations triggered by program buttons 1018 may yield different end products due to different operation parameters resulting from different operation mode buttons 1006, 1008 that are selected.

Referring now to FIG. 9A, shown is a sequence of output displayed in a user interface of a micro-puree machine, according to some non-limiting embodiments or aspects. In particular, the sequence represents an animation sequence for wheel indicator 1010. The sequence includes a series of display frames, where at each display frame, zero, one, or more wheel segment indicators may be activated (e.g., zero, one, or more LED indicators thereof may be illuminated). In some non-limiting embodiments or aspects, the depicted sequence may be used for providing visual feedback to a user regarding the progress of a retraction operation (e.g., retraction of a plunger, shaft, and/or blade within and/or from a bowl). It will be appreciated that the depicted sequence may also be used for showing progress of an operation from beginning (e.g., 0% progress) to completion (e.g., 100% progress). While the sequence is described below in a right-to-left (e.g., frame 1102 to frame 1112) order, it will also be appreciated that the depicted display frames of the sequence may also be carried out from left-to-right (e.g., frame 1112 to frame 1102) to represent stages of progress from beginning to completion. It will also be appreciated that the depicted frames may be rotated (e.g., 90 degrees, 180 degrees, 270 degrees) in practical embodiments to show progress from beginning to completion.

In some non-limiting embodiments or aspects, 0% progress may be shown using display frame 1102. In frame 1102, all wheel segment LED indicators of wheel indicator 1010 may be turned off (e.g., not illuminated). Frame 1102 may be displayed when progress is closest to 0% (e.g., 0%-10%), when progress has not yet reached the next milestone (e.g., 20%), and/or the like. When progress has become closer to 20% (e.g., reaching 10% or more), or the next progress milestone is reached (e.g., 20%), frame 1102 of wheel indicator 1010 may be updated by controller to frame 1104.

In some non-limiting embodiments or aspects, 20% progress may be shown using display frame 1104. In frame 1104, one wheel segment LED indicator (e.g., the lowest-most LED indicator) of wheel indicator 1010 may be turned on (e.g., illuminated), while the other wheel segment LED indicators may be turned off (e.g., not illuminated). Frame 1104 may be displayed when progress is closest to 20% (e.g., 10%-30%), when progress has not yet reached the next milestone (e.g., 40%), and/or the like. When progress has become closer to 40% (e.g., reaching 30% or more), or the next progress milestone is reached (e.g., 40%), frame 1104 of wheel indicator 1010 may be updated by controller to frame 1106.

In some non-limiting embodiments or aspects, 40% progress may be shown using display frame 1106. In frame 1106, three wheel segment LED indicators (e.g., the three lowest LED indicators) of wheel indicator 1010 may be turned on (e.g., illuminated), while the other wheel segment LED indicators may be turned off (e.g., not illuminated). Frame 1106 may be displayed when progress is closest to 40% (e.g., 30%-50%), when progress has not yet reached the next milestone (e.g., 60%), and/or the like. When progress has become closer to 60% (e.g., reaching 50% or more), or the next progress milestone is reached (e.g., 60%), frame 1106 of wheel indicator 1010 may be updated by controller to frame 1108.

In some non-limiting embodiments or aspects, 60% progress may be shown using display frame 1108. In frame 1108, five wheel segment LED indicators (e.g., the five lowest LED indicators) of wheel indicator 1010 may be turned on (e.g., illuminated), while the other wheel segment LED indicators may be turned off (e.g., not illuminated). Frame 1108 may be displayed when progress is closest to 60% (e.g., 50%-70%), when progress has not yet reached the next milestone (e.g., 80%), and/or the like. When progress has become closer to 80% (e.g., reaching 70% or more), or the next progress milestone is reached (e.g., 80%), frame 1108 of wheel indicator 1010 may be updated by controller to frame 1110.

In some non-limiting embodiments or aspects, 80% progress may be shown using display frame 1110. In frame 1110, seven wheel segment LED indicators (e.g., the seven lowest LED indicators) of wheel indicator 1010 may be turned on (e.g., illuminated), while the remaining wheel segment LED indicator may be turned off (e.g., not illuminated). Frame 1110 may be displayed when progress is closest to 80% (e.g., 70%-90%), when progress has not yet reached the next milestone (e.g., 100%), and/or the like. When progress has become closer to 100% (e.g., reaching 90% or more), or the next progress milestone is reached (e.g., 100%), frame 1110 of wheel indicator 1010 may be updated by controller to frame 1112.

In some non-limiting embodiments or aspects, 100% progress may be shown using display frame 1112. In frame 1112, all wheel segment LED indicators may be turned on (e.g., illuminated). Frame 1112 may be displayed when progress is closest to 100% (e.g., 90% or more), when progress has reached the final milestone (e.g., 100%), and/or the like. Using the foregoing logic, the controller may activate wheel indicator 1010 as described above to indicate that plunger, shaft, and/or blade are being retracted (and to illustrate the level of progress of such retraction).

Referring now to FIG. 9B, shown is a sequence of output displayed in a user interface of a micro-puree machine, according to some non-limiting embodiments or aspects. In particular, the sequence represents an animation sequence for seven-segment display 1012. The sequence includes a series of display frames, where at each display frame, one segment of seven-segment display 1012 may be activated (e.g., an LED indicator thereof may be illuminated). In some non-limiting embodiments or aspects, the depicted sequence may be used for providing visual feedback of the release of a lever (e.g., lever 730, lever 830). It will be appreciated that the depicted sequence may also be used for showing progress of an operation. It will be appreciated that the sequence may be animated in a left-to-right (e.g., frame 1122 to frame 1132) order, or from right-to-left (e.g., frame 1132 to frame 1122) to represent progress.

In some non-limiting embodiments or aspects, the sequence may be activated in an order that resembles counter-clockwise rotation of a segment of seven-segment display 1012. For example, a cycle of the following frames may be activated, one at a time: frame 1122, frame 1124, frame 1126, frame 1128, frame 1130, and frame 1132. In this manner, each single activated segment is illuminated one frame at a time, to create the appearance of the segment traveling in a counter-clockwise rotation about seven-segment display 1012. In some non-limiting embodiments or aspects, the sequence may be activated in an order that resembles clockwise rotation of a segment of seven-segment display 1012. For example, a cycle of the following frames may be activated, one at a time: frame 1132, frame 1130, frame 1128, frame 1126, frame 1124, and frame 1122. In this manner, each single activated segment is illuminated one frame at a time, to create the appearance of the segment traveling in a clockwise rotation about seven-segment display 1012. In either or both of these configurations, the controller may activate seven-segment display 1012, as described above, to indicate that the lever has been released and is returning to a neutral state.

Referring now to FIG. 10A, shown is exemplary displayed output in a user interface of a micro-puree machine, according to some non-limiting embodiments or aspects. In particular, depicted are configurations of illuminated indicators within central display 1013 to convey information about a detected exception. For example, shown are configurations of seven-segment display 1012 within wheel indicator 1010 to convey the following information: “E” (e.g., representative of “error” or “exception”), “1” (e.g., representative of exception code 1), “2” (e.g., representative of exception code 2), “3” (e.g., representative of exception code 3), “4” (e.g., representative of exception code 4), “5” (e.g., representative of exception code 5), and “6” (e.g., representative of exception code 6). Other numbers may be shown in seven-segment display 1012, as shown in FIG. 10B. It will be appreciated that seven-segment display 1012 may also be used to depict other letters, such as “A”, “C”, “F”, “G”, “H”, “J”, “L”, “P”, “S”, “U”, “b”, “d”, “e”, “g”, “h”, “o”, and “u”, among others.

Referring now to FIG. 10B, shown is exemplary displayed output in a user interface of a micro-puree machine, according to some non-limiting embodiments or aspects. In particular, depicted are configurations of illuminated indicators of seven-segment display 1012 to convey the following information: “1” (e.g., representative of exception code 1, or 1 minute remaining), “2” (e.g., representative of exception code 2, or 2 minutes remaining), “3” (e.g., representative of exception code 3, or 3 minutes remaining), “4” (e.g., representative of exception code 4, or 4 minutes remaining), “5” (e.g., representative of exception code 5, or 5 minutes remaining), “6” (e.g., representative of exception code 6, or 6 minutes remaining), “7” (e.g., representative of exception code 7, or 7 minutes remaining), “8” (e.g., representative of exception code 8, or 8 minutes remaining), “9” (e.g., representative of exception code 9, or 9 minutes remaining), and “E” (e.g., representative of “error” or “exception”).

Referring now to FIG. 11, shown is a sequence of output displayed in a user interface of a micro-puree machine, according to some non-limiting embodiments or aspects. In particular, the sequence represents an animation sequence for wheel indicator 1010. The sequence includes a series of display frames, where at each display frame, zero, one, or more wheel segment indicators may be activated (e.g., zero, one, or more LED indicators thereof may be illuminated, including in a constant illumination, a blinking illumination, and/or the like). Non-illuminated indicators 1204 are rendered in middle-tone gray, blinking indicators 1206 are rendered in dark-tone gray, and illuminated indicators 1202 are rendered in light-tone gray. In some non-limiting embodiments or aspects, the depicted sequence may be used for providing visual feedback to a user regarding the progress of a processing operation (e.g., mixing of frozen ingredients in a bowl). It will be appreciated that the depicted sequence may also be used for showing progress of an operation from beginning (e.g., 0% progress) to completion (e.g., 100% progress). While the sequence is described below in a left-to-right order, it will also be appreciated that the depicted display frames of the sequence may also be carried out from right-to-left to represent stages of progress from beginning to completion. It will also be appreciated that the depicted frames may be rotated (e.g., 90 degrees, 180 degrees, 270 degrees) in practical embodiments to show progress from beginning to completion.

In some non-limiting embodiments or aspects, 0-12.5% progress of a processing operation may be represented by one intermittent illuminated wheel segment indicator, which may be set to blink (e.g., in a cycle of intervals, including an on-interval followed by an off-interval, each having a duration of 0.5 seconds). The remaining wheel segment indicators may remain off (e.g., not illuminated).

In some non-limiting embodiments or aspects, 12.5-25% progress of a processing operation may be represented by one constantly illuminated wheel segment indicator, and one intermittent illuminated wheel segment indicator (positioned adjacently the former), which may be set to blink (e.g., in a cycle of intervals, including an on-interval followed by an off-interval, each having a duration of 0.5 seconds). The remaining wheel segment indicators may remain off (e.g., not illuminated).

In some non-limiting embodiments or aspects, 25-37.5% progress of a processing operation may be represented by two constantly illuminated wheel segment indicators (positioned adjacent each other), and one intermittent illuminated wheel segment indicator (positioned adjacently the former), which may be set to blink (e.g., in a cycle of intervals, including an on-interval followed by an off-interval, each having a duration of 0.5 seconds). The remaining wheel segment indicators may remain off (e.g., not illuminated).

In some non-limiting embodiments or aspects, 37.5-50% progress of a processing operation may be represented by three constantly illuminated wheel segment indicators (positioned adjacent each other), and one intermittent illuminated wheel segment indicator (positioned adjacently the former), which may be set to blink (e.g., in a cycle of intervals, including an on-interval followed by an off-interval, each having a duration of 0.5 seconds). The remaining wheel segment indicators may remain off (e.g., not illuminated).

In some non-limiting embodiments or aspects, 50-62.5% progress of a processing operation may be represented by four constantly illuminated wheel segment indicators (positioned adjacent each other), and one intermittent illuminated wheel segment indicator (positioned adjacently the former), which may be set to blink (e.g., in a cycle of intervals, including an on-interval followed by an off-interval, each having a duration of 0.5 seconds). The remaining wheel segment indicators may remain off (e.g., not illuminated).

In some non-limiting embodiments or aspects, 62.5-75% progress of a processing operation may be represented by five constantly illuminated wheel segment indicators (positioned adjacent each other), and one intermittent illuminated wheel segment indicator (positioned adjacently the former), which may be set to blink (e.g., in a cycle of intervals, including an on-interval followed by an off-interval, each having a duration of 0.5 seconds). The remaining wheel segment indicators may remain off (e.g., not illuminated).

In some non-limiting embodiments or aspects, 75-87.5% progress of a processing operation may be represented by six constantly illuminated wheel segment indicators (positioned adjacent each other), and one intermittent illuminated wheel segment indicator (positioned adjacently the former), which may be set to blink (e.g., in a cycle of intervals, including an on-interval followed by an off-interval, each having a duration of 0.5 seconds). The remaining wheel segment indicator may remain off (e.g., not illuminated).

In some non-limiting embodiments or aspects, 87.5-100% progress of a processing operation may be represented by seven constantly illuminated wheel segment indicators (positioned adjacent each other), and one intermittent illuminated wheel segment indicator (positioned adjacently the former), which may be set to blink (e.g., in a cycle of intervals, including an on-interval followed by an off-interval, each having a duration of 0.5 seconds). When 100% progress is achieved, all eight wheel segment indicators may be constantly illuminated.

Referring now to FIG. 12, shown is a sequence of output displayed in a user interface of a micro-puree machine, according to some non-limiting embodiments or aspects. In particular, the sequence represents an animation sequence for wheel indicator 1010. The sequence includes a series of display frames, where at each display frame, zero, one, or more wheel segment indicators may be activated (e.g., zero, one, or more LED indicators thereof may be illuminated). Non-illuminated indicators 1204 are rendered in middle-tone gray, and illuminated indicators 1202 are rendered in light-tone gray. In some non-limiting embodiments or aspects, the depicted sequence may be used for providing visual feedback to a user regarding the progress of an extruding operation (e.g., ejecting blended frozen ingredients from a bowl). While the sequence is described in connection with progress of extrusion, where 100% represents a full bowl that has not yet been extruded yet and 0% represents an empty bowl that has been fully extruded, it will be appreciated that the depicted sequence may also be used for showing progress of an operation from beginning to completion. While the sequence is described below in a left-to-right order, it will also be appreciated that the depicted display frames of the sequence may also be carried out from right-to-left to represent stages of progress from beginning to completion. It will also be appreciated that the depicted frames may be rotated (e.g., 90 degrees, 180 degrees, 270 degrees) in practical embodiments to show progress from beginning to completion.

In some non-limiting embodiments or aspects, a bowl containing approximately 100% of its contents (e.g., extrusion is approximately 0% complete) may be represented by all eight wheel segment indicators of wheel indicator 1010 being activated (e.g., LED indicators thereof illuminated). When the bowl is closest to 100% full (e.g., 90% full or more), or when the extrusion progress has not yet reached the next milestone (e.g., 80% full bowl), the first display frame demarcated “100%” may be displayed.

In some non-limiting embodiments or aspects, a bowl containing approximately 80% of its contents (e.g., extrusion is approximately 20% complete) may be represented by seven wheel segment indicators of wheel indicator 1010 being activated (e.g., the lowest LED indicators thereof illuminated), and one wheel segment indicator of wheel indicator 1010 being deactivated (e.g., highest LED indicator thereof not illuminated). When the bowl is closest to 80% full (e.g., 70-90% full), or when the extrusion progress has not yet reached the next milestone (e.g., 60% full bowl), the second display frame demarcated “80%” may be displayed.

In some non-limiting embodiments or aspects, a bowl containing approximately 60% of its contents (e.g., extrusion is approximately 40% complete) may be represented by five wheel segment indicators of wheel indicator 1010 being activated (e.g., the lowest LED indicators thereof illuminated), and three wheel segment indicators of wheel indicator 1010 being deactivated (e.g., highest LED indicators thereof not illuminated). When the bowl is closest to 60% full (e.g., 50-70% full), or when the extrusion progress has not yet reached the next milestone (e.g., 40% full bowl), the third display frame demarcated “60%” may be displayed.

In some non-limiting embodiments or aspects, a bowl containing approximately 40% of its contents (e.g., extrusion is approximately 60% complete) may be represented by three wheel segment indicators of wheel indicator 1010 being activated (e.g., the lowest LED indicators thereof illuminated), and five wheel segment indicators of wheel indicator 1010 being deactivated (e.g., highest LED indicators thereof not illuminated). When the bowl is closest to 40% full (e.g., 30-50% full), or when the extrusion progress has not yet reached the next milestone (e.g., 20% full bowl), the fourth display frame demarcated “40%” may be displayed.

In some non-limiting embodiments or aspects, a bowl containing approximately 20% of its contents (e.g., extrusion is approximately 80% complete) may be represented by one wheel segment indicator of wheel indicator 1010 being activated (e.g., the lowest LED indicator thereof illuminated), and seven wheel segment indicators of wheel indicator 1010 being deactivated (e.g., highest LED indicators thereof not illuminated). When the bowl is closest to 20% full (e.g., 10-30% full), or when the extrusion progress has not yet reached the next milestone (e.g., 0% full bowl), the fifth display frame demarcated “20%” may be displayed.

In some non-limiting embodiments or aspects, a bowl containing approximately 0% of its contents (e.g., extrusion is approximately 100% complete) may be represented by all wheel segment indicators of wheel indicator 1010 being deactivated (e.g., highest LED indicators thereof not illuminated). When the bowl is closest to 0% full (e.g., 10% or less full), or when the extrusion progress has reached the final milestone (e.g., 0% full bowl), the sixth display frame demarcated “0%” may be displayed.

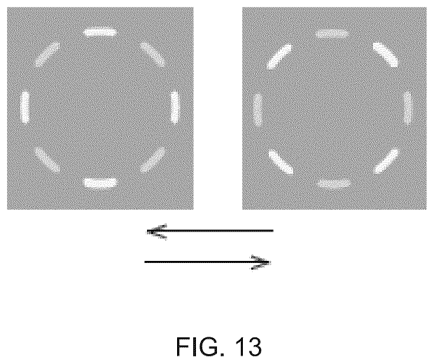

Referring now to FIG. 13, shown is a sequence of output displayed in a user interface of a micro-puree machine, according to some non-limiting embodiments or aspects. In particular, the sequence represents an animation sequence for wheel indicator 1010. The sequence includes an alternating use of two display frames, where each display frame has half its wheel segment indicators activated (e.g., LED indicators thereof illuminated), and the other half of its wheel segment indicators deactivated (e.g., LED indicators thereof illuminated), configured in an every-other-indicator arrangement. The wheel segment indicators that are activated in the left display frame are not activated in the right display frame, and the wheel segment indicators that are not activated in the left display frame are activated in the right display frame. As shown in FIG. 13 for ease of reference, non-illuminated indicators are rendered in gray, and illuminated indicators are rendered in white. In some non-limiting embodiments or aspects, the depicted sequence may be used for providing visual feedback to a user, such as an in-progress animation, an idle animation, a wait animation, and/or the like. The display frames may be displayed in an alternating manner at predetermined time intervals, such as 0.5 seconds each. When a triggering event is detected by the controller (e.g., an operation begins, the operation requires the user to wait, an operation is completed and the micro-puree machine is waiting for further input), the controller may cause the depicted sequence to begin displaying in wheel indicator 1010.

Referring now to FIG. 14, shown is a schematic diagram of a micro-puree machine 1402, according to some non-limiting embodiments or aspects. As shown, micro-puree machine 1402 may include controller 1404 (e.g., including one or more processors), a user interface 1406 (e.g., user interface 1000), a memory 1407 (e.g., a non-transitory computer readable medium configured to store data, including data of operation parameters), a blending assembly 1408 (e.g., a shaft (e.g., driven shaft 250, driven shaft 250″, driven shaft 754), blade (e.g., blade 300, blade 713, etc.), an extruding assembly 1410 (e.g., a shaft (e.g., driven shaft 758), a plunger (e.g., plunger 454, plunger 602, plunger 702), etc.), and a bowl (e.g., bowl assembly 350, processing bowl assembly 717, bowl extruding assembly 750, bowl 352, bowl 352″, bowl 752, etc.). Controller 1404 may control operation of one or more processing operations, as described herein, using blending assembly 1408. Controller 1404 may further control one or more extruding operations, as described herein, using extruding assembly 1410. Controller 1404 may receive user input for control of one or more operations via user interface 1406, and controller 1404 may further provide output to user for feedback via user interface 1406. Control of operations by controller 1404 and feedback to user via user interface 1406 may depend on the position of bowl 1412, as described above. In some non-limiting embodiments or aspects, user interface 1406 may include or be associated with controller 1404 and/or memory 1407.

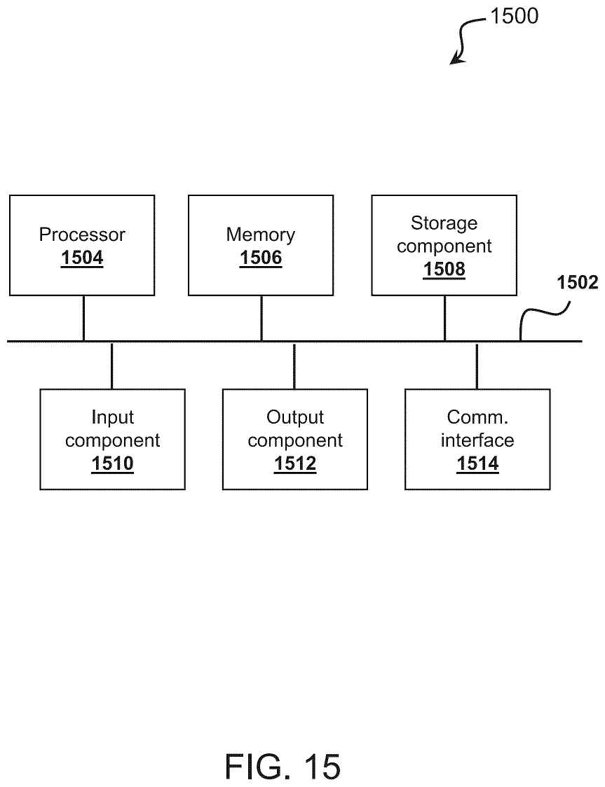

Referring now to FIG. 15, shown is a diagram of example components of a device 1500 according to non-limiting embodiments. Device 1500 may correspond to controller 1404, user interface 1406, user interface 1000, and/or memory 1407, as an example. In some non-limiting embodiments, such systems or devices may include at least one device 1500 and/or at least one component of device 1500. The number and arrangement of components shown are provided as an example. In some non-limiting embodiments, device 1500 may include additional components, fewer components, different components, or differently arranged components than those shown. Additionally, or alternatively, a set of components (e.g., one or more components) of device 1500 may perform one or more functions described as being performed by another set of components of device 1500.

As shown in FIG. 15, device 1500 may include a bus 1502, a processor 1504, memory 1506, a storage component 1508, an input component 1510, an output component 1512, and a communication interface 1514. Bus 1502 may include a component that permits communication among the components of device 1500. In some non-limiting embodiments, processor 1504 may be implemented in hardware, firmware, or a combination of hardware and software. For example, processor 1504 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 1506 may include random access memory (RAM), read only memory (ROM), and/or another type of dynamic or static storage device (e.g., flash memory, magnetic memory, optical memory, etc.) that stores information and/or instructions for use by processor 1504.

With continued reference to FIG. 15, storage component 1508 may store information and/or software related to the operation and use of device 1500. For example, storage component 1508 may include a hard disk (e.g., a magnetic disk, an optical disk, a magneto-optic disk, a solid-state disk, etc.) and/or another type of computer-readable medium. Input component 1510 may include a component that permits device 1500 to receive information, such as via user input (e.g., a touch screen display, a keyboard, a keypad, a mouse, a button, a switch, a microphone, etc.). Additionally, or alternatively, input component 1510 may include a sensor for sensing information (e.g., a global positioning system (GPS) component, an accelerometer, a gyroscope, an actuator, etc.). Output component 1512 may include a component that provides output information from device 1500 (e.g., a display, a speaker, one or more light-emitting diodes (LEDs), etc.). Communication interface 1514 may include a transceiver-like component (e.g., a transceiver, a separate receiver and transmitter, etc.) that enables device 1500 to communicate with other devices, such as via a wired connection, a wireless connection, or a combination of wired and wireless connections. Communication interface 1514 may permit device 1500 to receive information from another device and/or provide information to another device. For example, communication interface 1514 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 1500 may perform one or more processes described herein. Device 1500 may perform these processes based on processor 1504 executing software instructions stored by a computer-readable medium, such as memory 1506 and/or storage component 1508. A computer-readable medium may include any non-transitory memory device. A memory device includes memory space located inside of a single physical storage device or memory space spread across multiple physical storage devices. Software instructions may be read into memory 1506 and/or storage component 1508 from another computer-readable medium or from another device via communication interface 1514. When executed, software instructions stored in memory 1506 and/or storage component 1508 may cause processor 1504 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

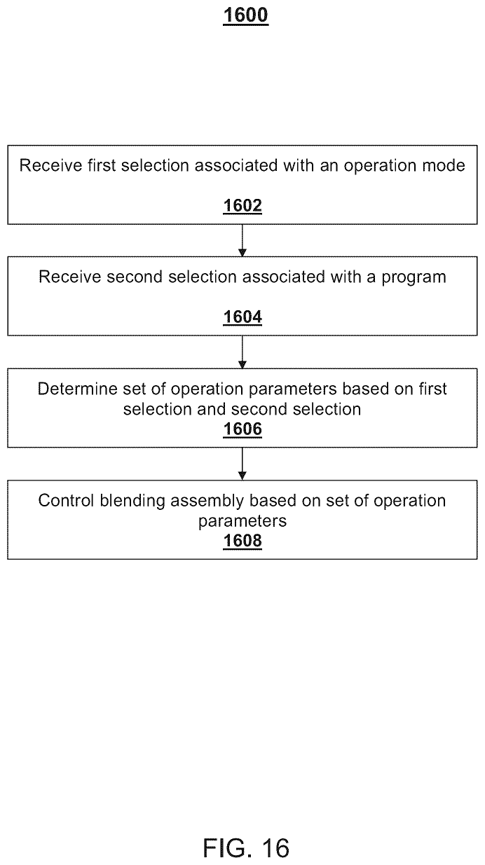

Referring now to FIG. 16, shown is a flow diagram of a method 1600 for controlling a micro-puree machine, according to some non-limiting embodiments or aspects. The steps shown in FIG. 16 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step.

As shown in FIG. 16, method 1600 may include, at step 1602, receiving a first selection associated with an operation mode. For example, controller 1404 may receive, via user interface 1406, a first selection associated with an operation mode based on an activated operation mode input component (e.g., an activated operation mode button) of the at least two operation mode input components.

As shown in FIG. 16, method 1600 may include, at step 1604, receiving a second selection associated with a program. For example, controller 1404 may receive, via user interface 1406, a second selection associated with a program based on an activated program input component (e.g., an activated program button) of the at least one program input component.

As shown in FIG. 16, method 1600 may include, at step 1606, determining a set of operation parameters based on the first selection and the second selection. For example, controller 1404 may determine a set of operation parameters for controlling blending assembly 1408 based on the first selection and the second selection.

In some non-limiting embodiments or aspects, the set of operation parameters determined based on the first selection and the second selection may vary based on the activated operation mode input component of the at least two operation mode input components. In some non-limiting embodiments or aspects, the at least one program input component may include a plurality of program input components. In some non-limiting embodiments or aspects, the set of operation parameters determined based on the first selection and the second selection may vary based on the activated program input component of the plurality of program input components.

As shown in FIG. 16, method 1600 may include, at step 1608, controlling blending assembly 1408 based on the set of operation parameters. For example, controller 1404 may control blending assembly 1408 (e.g., on-state, off-state, speed, shaft distance, power, time operating, etc.) based on the set of operation parameters determined at step 1606.

In some non-limiting embodiments or aspects, controller 1404 may receive a third selection of a special program (e.g., after step 1604) based on an activated special program input component (e.g., a special program button) of the at least one special program input component. Controller 1404 may determine an updated set of operation parameters for controlling the blending assembly based on the third selection and control blending assembly 1408 based on the updated set of operation parameters. In some non-limiting embodiments or aspects, the special program input component may include a retract input component (e.g., a retract button), and controller 1404 may be configured to detect activation of the retract button and retract at least one shaft of blending assembly 1408 or extruding assembly 1410 in response to activation of the retract input component. When retracting the at least one shaft, controller 1404 may be further configured to activate at least one locking mechanism of the micro-puree machine to prevent removal of the bowl during retraction of the at least one shaft.

In some non-limiting embodiments or aspects, controller 1404 may determine the set of operation parameters at step 1608 based on at least one record stored in memory 1407 that is stored based on reference to one or more selection. In some non-limiting embodiments or aspects, the at least one record may include data of an expected processing time. When controlling blending assembly 1408 based on the set of operation parameters, controller 1404 may be further configured to determine an actual processing time of blending assembly 1408 and compare the actual processing time to the expected processing time. In response to the actual processing time exceeding the expected processing time, controller 1404 may generate at least one alert (e.g., a visual alert, an aural alert, etc.) in user interface 1406.

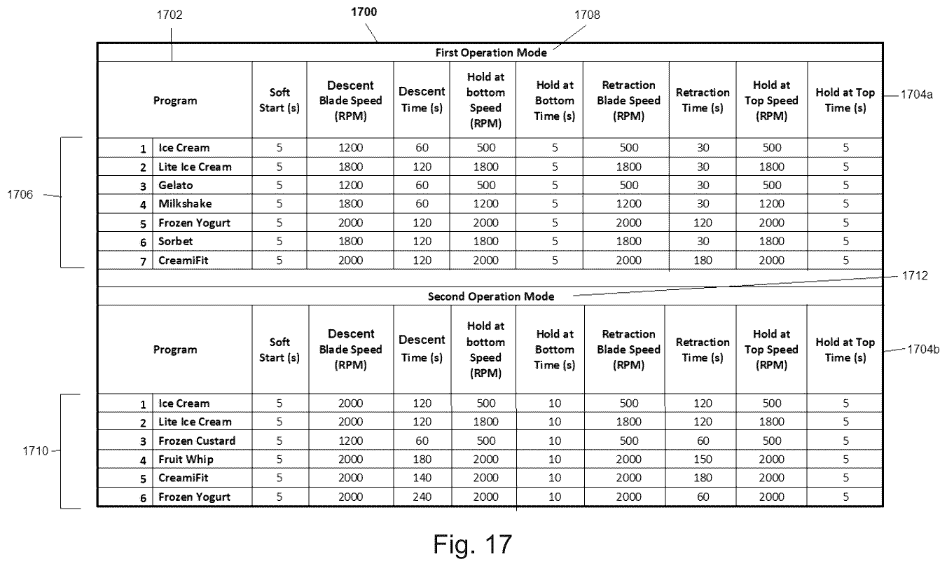

Referring now to FIG. 17, table 1700 shows examples of various operation parameters for food processing programs for the micro-puree machines disclosed herein, according to some non-limiting embodiments or aspects. For the purpose of illustration, column 1702 of table 1700 lists examples of programs that may be associated with or selectable by actuation of one or more of the program buttons 1018 and/or the user interface 1000. Rows 1704a and 1704b of table 1700 list examples of operation parameters that may be implemented by the micro-puree machine (for example, by the controller 1404) to control operation of one or more components or assemblies of the micro-puree machine, such as the blending assembly 1408 and/or components thereof.

For example, an operation parameter may include a “Soft Start” time duration for one or more components of the blending assembly 1408 to reach a starting speed, position, or other operational metric. In some non-limiting embodiments or aspects, the “Soft Start” may have a duration of approximately 5 seconds.

In some non-limiting embodiments or aspects, an operation parameter may include a “Descent Blade Speed” indicating a rotational speed of the blade (e.g., blade 300, blade 713, etc.) as the blade descends or otherwise moves axially into a bowl (e.g., bowl assembly 350, processing bowl assembly 717, bowl extruding assembly 750, bowl 352, bowl 352″, bowl 752, etc.) to interact with the ingredients therein. The “descent” of the blade refers to the axial movement deeper into a length or depth of the bowl, and is not necessarily a vertical axial movement. For example, in the horizontal configuration of the bowl in FIG. 1B, the direction of descent would extend horizontally away from the collar 500′ along a longitudinal axis of the driven shaft 250 and into the interior of the bowl 352″. A similar horizontal direction of descent exists for the example illustrated in FIG. 5C. In some non-limiting embodiments or aspects, the “Descent Blade Speed” may be between approximately 1200 RPM and approximately 2000 RPM, with some examples of operation parameters for indicated programs provided in table 1700.

In some non-limiting embodiments or aspects, an operation parameter may include a “Descent Time” duration for the blade to axially traverse at least a portion of the bowl. In some non-limiting embodiments or aspects, the “Descent Time” may be between approximately 60 seconds and approximately 240 seconds, with some examples of operation parameters for indicated programs provided in table 1700.

In some non-limiting embodiments or aspects, an operation parameter may include a “Hold at Bottom Speed” indicating a rotational speed of the blade as the blade is in a static axial position within the bowl. The static axial position of the blade for the “Hold at Bottom Speed” may be at the end of the descent of the blade within the bowl. The static axial position of the blade may be adjacent to and/or axially spaced from a bottom surface of the bowl. In some non-limiting embodiments or aspects, the “Hold at Bottom Speed” may be between approximately 500 RPM and approximately 2000 RPM, with some examples of operation parameters for indicated programs provided in table 1700.

In some non-limiting embodiments or aspects, an operation parameter may include a “Hold at Bottom Time” duration for the blade to rotate at the static axial position within the bowl at the end of the descent as described herein. In some non-limiting embodiments or aspects, the “Hold at Bottom Time” may have a duration between approximately 5 seconds and approximately 10 seconds, with some examples of operation parameters for indicated programs provided in table 1700.

In some non-limiting embodiments or aspects, an operation parameter may include a “Retraction Blade Speed” indicating a rotational speed of the blade as the blade retracts or otherwise moves axially out of or away from the bowl (e.g., in a direction opposite to the descent described herein). In some non-limiting embodiments or aspects, the “Retraction Blade Speed” may be between approximately 500 RPM and approximately 2000 RPM, with some examples of operation parameters for indicated programs provided in table 1700.

In some non-limiting embodiments or aspects, an operation parameter may include a “Retraction Time” duration for the blade to axially exit or retrace at least a portion of the descent with respect to the bowl. In some non-limiting embodiments or aspects, the “Retraction Time” may be between approximately 30 seconds and approximately 180 seconds, with some examples of operation parameters for indicated programs provided in table 1700.

In some non-limiting embodiments or aspects, an operation parameter may include a “Hold at Top Speed” indicating a rotational speed of the blade as the blade is in a static axial position within the bowl. The static axial position of the blade for the “Hold at Top Speed” may be at the end of the retraction of the blade with respect to the bowl. The static axial position of the blade may be adjacent to and/or axially spaced from a top surface of the bowl. In some non-limiting embodiments or aspects, the “Hold at Top Speed” may be between approximately 500 RPM and approximately 2000 RPM, with some examples of operation parameters for indicated programs provided in table 1700.

In some non-limiting embodiments or aspects, an operation parameter may include a “Hold at Top Time” duration for the blade to rotate at the static axial position within the bowl at the end of the retraction as described herein. In some non-limiting embodiments or aspects, the “Hold at Top Time” may have a duration of approximately 5 seconds.

As described herein, each program may include or be associated with a first set of operation parameters for a first operation mode, and a second set of operation parameters for a second operation mode. The first and second modes may include, for example, “Soft Serve” or “Scoop” selections, as described herein. Table 1700 illustrates non-limiting examples of operation parameters for a first plurality of programs 1706 under a first operation mode 1708, and also includes non-limiting examples of a second plurality of operation parameters for a second plurality of programs 1710 under a second operation mode 1712. The first plurality of programs may be the same as the second plurality of programs, with the associated operation parameters differing for each program under the selected operation mode. In one example or aspect, the first plurality of programs may differ from the second plurality of programs, with one or more programs only operable under a single selected operation mode.

In one example, the program “Ice Cream” has a first set of operation parameters under the first operation mode (e.g., Descent Blade Speed of 1200 RPM; Descent Time of 60 seconds; Retraction Blade Speed of 500 RPM, Retraction Time of 30 seconds, etc.) that is different from the second set of operation parameters under the second operation mode for the same “Ice Cream” program (e.g., Descent Blade Speed of 2000 RPM; Descent Time of 120 seconds; Retraction Blade Speed of 500 RPM, Retraction Time of 120 seconds, etc.). Each of the programs in the first plurality of programs 1706 may have a second set of operation parameters for operation under the second operation mode 1712, and each of the programs in the second plurality of programs 1710 may have a second set of operation parameters for operation under the first operation mode 1708.

In some non-limiting embodiments or aspects, the first operation mode 1708 and associated operation parameters in table 1700 may be for the “Scoop” operation mode for preparing manually-scoopable processed ingredients as disclosed herein, and the second operation mode 1712 and associated operation parameters in table 1700 may be for the “Soft Serve” operation mode for preparing extrudable processed ingredients as disclosed herein.

The operation parameters may be modified and/or configured to attain a desired consistency and/or density for the processed ingredients. In some non-limiting embodiments or aspects, the operation parameters may be selected, modified, and/or configured to attain a desired consistency, overrun (e.g., the amount of air incorporated), and/or density based at least in part on the composition, percentage by weight, percentage by volume, and/or percentage by caloric value of one or more ingredients within the food compound to be processed by the micro-puree machine. Such ingredients may include for example, sugar, milk (or other dairy product including but not limited to heavy cream, cream cheese, etc.), non-dairy liquids, powdered ingredients (including but not limited to milk powder, pudding mix, xanthan, cornstarch, salt, etc.), gelatin, etc. The operation parameters may be modified and/or configured for such ingredients and/or combinations thereof.

For example, one or more of the operation parameters may be selected, modified, and/or configured for a recipe of a food compound to be processed having more than, less than, or at least, a threshold amount of sugar. In another example, one or more of the operation parameters may be selected, modified, and/or configured for a recipe of a food compound to be processed having more than, less than, or at least, a threshold amount of milk (or other dairy ingredient). In another example, one or more of the operation parameters may be selected, modified, and/or configured for a recipe of a food compound to be processed having more than, less than, or at least, a threshold amount of protein. In another example, one or more of the operation parameters may be selected, modified, and/or configured for a recipe of a food compound to be processed having more than, less than, or at least, a threshold amount of fat. In another example, one or more of the operation parameters may be selected, modified, and/or configured for a recipe of a food compound to be processed having more than, less than, or at least, a threshold amount of carbohydrates.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A micro-puree machine comprising:
a blending assembly configured to process frozen ingredients in a bowl that is removably attachable to the micro-puree machine;
a user interface comprising at least two operation mode input components and at least one program input component, wherein at least one of the at least two operation mode input components is associated with an operation mode suitable for extrudable processed ingredients; and
a controller, wherein the controller is configured to:
receive, via the user interface, a first selection associated with an operation mode based on an activated operation mode input component of the at least two operation mode input components;
receive, via the user interface, a second selection associated with a program based on an activated program input component of the at least one program input component;
determine a set of operation parameters for controlling the blending assembly based on the first selection and the second selection, wherein the set of operation parameters varies based on the activated operation mode input component of the at least two operation mode input components; and
control the blending assembly based on the set of operation parameters.

2. The micro-puree machine of claim 1, wherein the set of operation parameters includes a descent blade speed for the blending assembly.

3. The micro-puree machine of claim 2, wherein the descent blade speed is between 1200 RPM and 2000 RPM.

4. The micro-puree machine of claim 1, wherein the set of operation parameters includes a descent time for the blending assembly.

5. The micro-puree machine of claim 4, wherein the descent time is between 60 seconds and 240 seconds.

6. The micro-puree machine of claim 1, wherein the set of operation parameters includes a hold at bottom blade speed for the blending assembly.

7. The micro-puree machine of claim 6, wherein the hold at bottom blade speed is between 500 RPM and 2000 RPM.

8. The micro-puree machine of claim 1, wherein the set of operation parameters includes a retraction blade speed for the blending assembly.

9. The micro-puree machine of claim 8, wherein the retraction blade speed is between 500 RPM and 2000 RPM.

10. The micro-puree machine of claim 1, wherein the set of operation parameters includes a retraction time for the blending assembly.

11. The micro-puree machine of claim 10, wherein the retraction time is between 30 seconds and 180 seconds.

12. The micro-puree machine of claim 1, wherein the set of operation parameters includes a hold at top blade speed for the blending assembly.

13. The micro-puree machine of claim 12, wherein the hold at top blade speed is between 500 RPM and 2000 RPM.

14. The micro-puree machine of claim 1, further comprising an extruding assembly configured to extrude processed ingredients from the bowl.

15. The micro-puree machine of claim 1, wherein the program is associated with a first set of predetermined operating parameters for controlling the blending assembly for a first operation mode, and a second set of predetermined operating parameters for controlling the blending assembly for a second operation mode, wherein the first set of predetermined operating parameters is different than the second set of predetermined operating parameters.

16. The micro-puree machine of claim 1, wherein the first selection is associated with the operation mode suitable for extrudable processed ingredients.

17. A method of controlling a micro-puree machine comprising a blending assembly configured to process frozen ingredients in a bowl that is removably attachable to the micro-puree machine, a user interface comprising at least two operation mode input components and at least one program input component, wherein at least one of the at least two operation mode input components is associated with an operation mode suitable for extrudable processed ingredients, and a controller, the method comprising:
receiving, with the controller via the user interface, a first selection associated with an operation mode based on an activated operation mode input component of the at least two operation mode input components;
receiving, with the controller via the user interface, a second selection associated with a program based on an activated program input component of the at least one program input component;
determining, with the controller, a set of operation parameters for controlling the blending assembly based on the first selection and the second selection, wherein the set of operation parameters determined based on the first selection and the second selection varies based on the activated operation mode input component of the at least two operation mode input components; and
controlling, with the controller, the blending assembly based on the set of operation parameters.

18. The method of claim 17, wherein the at least one program input component comprises a plurality of program input components, and wherein the set of operation parameters determined based on the first selection and the second selection varies based on the activated program input component of the plurality of program input components.

19. The method of claim 17, wherein the program is associated with a first set of predetermined operating parameters for controlling the blending assembly for a first operation mode, and a second set of predetermined operating parameters for controlling the blending assembly for a second operation mode, wherein the first set of predetermined operating parameters is different than the second set of predetermined operating parameters.

20. The method of claim 17, wherein the first selection is associated with the operation mode suitable for extrudable processed ingredients.
